(19) United States
(12) Patent Application Publication
(10) Pub. No.: US 2026/0141731 A1
(43) Pub. Date: May 21, 2026

(54) AUTOMATIC HAZARD DETECTION AND REPORTING USING MULTI-MODAL MODELS

(71) Applicant: NVIDIA Corporation, Santa Clara, CA (US)

(72) Inventor: Julien François Jomier, Chapel Hill, NC (US)

(21) Appl. No.: 18/952,787

(22) Filed: Nov. 19, 2024

(51) Int. Cl. G06V 20/58; B60W 60/00; G06V 10/70; G06V 20/56; G08G 1/01

(52) U.S. Cl. CPC G06V 20/58; G06V 10/70; G06V 20/588; G08G 1/0133; B60W 60/00

(57) ABSTRACT

In various examples, techniques for automatic hazard detection and reporting using multi-modal models are described herein. Systems and methods described herein may use one or more machine learning models (model(s))—such as one or more vision-language models (and/or any other type of model)—to determine information for hazards within an environment. For instance, sensor data obtained using one or more sensors of a machine, along with data representing one or more prompts associated with identifying hazards, may be processed using the model(s). Based at least on the processing, the model(s) may generate output data representing information associated with a hazard, such as a type of hazard, a location of the hazard, and/or any other details related to the hazard.

### BACKGROUND

Determining information about road hazards—such as vehicle accidents blocking roads, the presence of emergency vehicles located on and/or proximate to roads, the presence of animals located on and/or proximate to roads, road construction, and/or the like—is important for both human driving as well as autonomous and semi-autonomous functionality of machines. As such, driving applications allow users to report information describing road hazards, such as the types of road hazards, the locations of the road hazards, and important details about the road hazards (how many vehicles are involved in an accident, wait times, etc.). Additionally, these driving applications then provide the reported information to other users that use the reported information to perform various driving tasks. For example, human drivers may reduce speeds when approaching road hazards and/or change routes to avoid road hazards.

However, conventional systems that provide these driving applications require user inputs—such as to report the information, verify the information, and/or update the information—which may increase the risk of danger from distracted drivers. For example, a driver that is reporting a road hazard using a driving application may be at least partially distracted when inputting the information into a user device. Additionally, conventional systems may receive inaccurate and/or incomplete information—such as from users that accidentally input the incorrect information and/or from nefarious users that purposely report incorrect information—and/or may not receive information for road hazards that are unreported. This incorrect, unreported, and/or incomplete information may also cause drivers to take unnecessary actions for road hazards that are not present and/or cause drivers that rely too much on the driving application to refrain from taking necessary actions for unreported road hazards.

### SUMMARY

Embodiments of the present disclosure relate to automatic hazard detection and reporting using multi-modal models. Systems and methods described herein may use one or more machine learning models—such as one or more vision language models (VLMs), one or more multi-modal language models (MMLMs), and/or any other type of model—to determine information associated with hazards located within an environment. For instance, sensor data obtained using one or more sensors of a machine—such as image data, audio data, LiDAR data, ultrasonic data, RADAR data, input data, and/or the like—may be processed using the model(s). In some examples, additional data is processed using the model(s), such as data representing one or more prompts associated with identifying hazards. Based at least on the processing, the model(s) may generate output data representing information associated with a hazard, such as a type of hazard, a location of the hazard, and/or any other details related to the hazard. Systems and methods described herein may then perform tasks using this information, such as proving this information to one or more application systems that notify other users about road hazards.

In contrast to conventional systems, the systems of the present disclosure, in some embodiments, may use the model(s) to automatically determine information associated with hazards and/or report the information to other users. As such, the systems of the present disclosure may require no and/or little input from users to identify and/or report hazards. This may increase the safety for users and/or pedestrians as compared to the conventional systems, such as by reducing driver distractions associated with reporting hazards. Additionally, this may increase the accuracy associated with reporting hazards as compared to the conventional systems since the model(s) may be configured to detect any number of hazards, generate information associated with the hazards, verify that the information is accurate using one or more techniques, and/or report the accurate information.

### BRIEF DESCRIPTION OF THE DRAWINGS

The present systems and methods for automatic hazard detection and reporting using multi-modal models are described in detail below with reference to the attached drawing figures, wherein:

FIG. 1A illustrates an example data flow diagram for a process of automatically determining and/or providing information associated with hazards, in accordance with some embodiments of the present disclosure;

FIG. 1B illustrates a data flow diagram of a process for training one or more machine learning models to determine information associated with hazards, in accordance with some embodiments of the present disclosure;

FIG. 2 illustrates an example of a machine navigating within an environment that includes multiple hazards, in accordance with some embodiments of the present disclosure;

FIG. 3 illustrates an example of using one or more machine learning models to determine information associated with hazards, in accordance with some embodiments of the present disclosure;

FIG. 4A illustrates an example of processing input data using one or more iterations to determine information associated with a hazard, in accordance with some embodiments of the present disclosure;

FIG. 4B illustrates an example of processing input data using one or more iterations associated with one or more prompts, in accordance with some embodiments of the present disclosure;

FIG. 5 illustrates an example of using speech to determine information associated with a hazard, in accordance with some embodiments of the present disclosure;

FIGS. 6A-6B illustrate an example of a user interface associated with an application that provides information associated with hazards, in accordance with some embodiments of the present disclosure;

FIG. 7 illustrates an example of one or more systems that are configured to perform one or more of the processes described herein, in accordance with some embodiments of the present disclosure;

FIG. 8 illustrates a flow diagram showing a method for automatically determining and providing information associated with a hazard, in accordance with some embodiments of the present disclosure;

FIG. 9 illustrates a flow diagram showing a method for determining how to report information associated with a hazard, in accordance with some embodiments of the present disclosure;

FIG. 10A is a block diagram of an example generative language model system suitable for use in implementing at least some embodiments of the present disclosure;

FIG. 10B is a block diagram of an example generative language model that includes a transformer encoder-decoder suitable for use in implementing at least some embodiments of the present disclosure;

FIG. 10C is a block diagram of an example generative language model that includes a decoder-only transformer architecture suitable for use in implementing at least some embodiments of the present disclosure;

FIG. 11A is an illustration of an example autonomous vehicle, in accordance with some embodiments of the present disclosure;

FIG. 11B is an example of camera locations and fields of view for the example autonomous vehicle of FIG. 11A, in accordance with some embodiments of the present disclosure;

FIG. 11C is a block diagram of an example system architecture for the example autonomous vehicle of FIG. 11A, in accordance with some embodiments of the present disclosure;

FIG. 11D is a system diagram for communication between cloud-based server(s) and the example autonomous vehicle of FIG. 11A, in accordance with some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

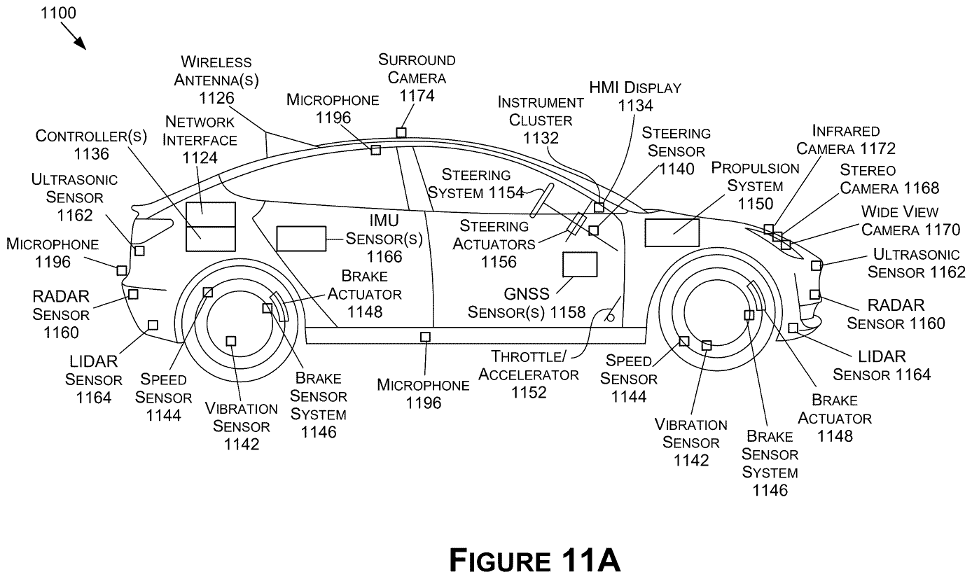

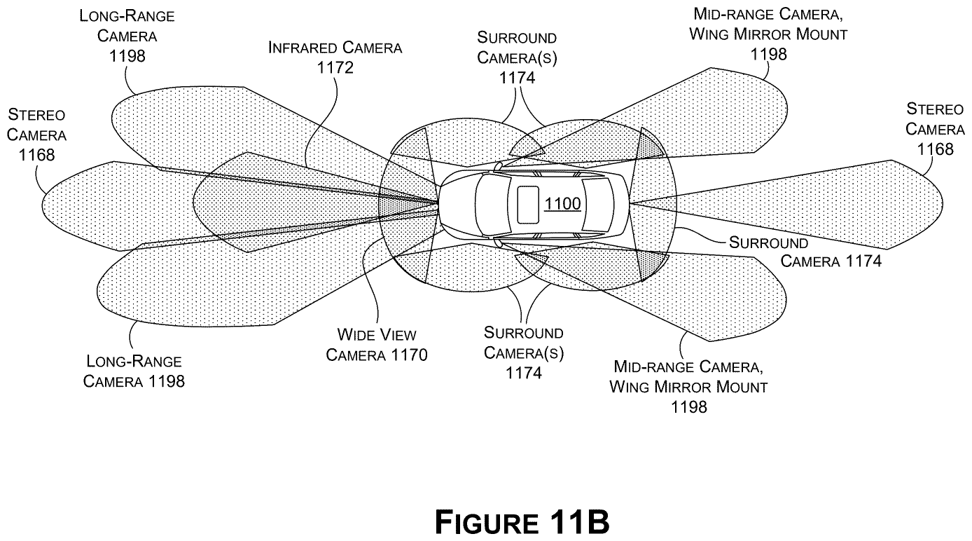

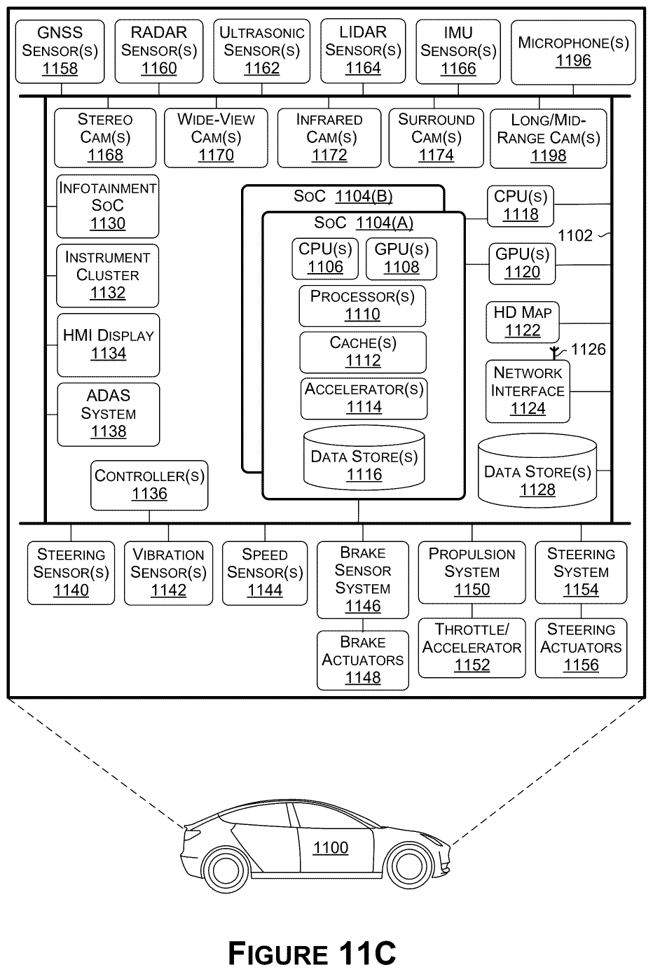

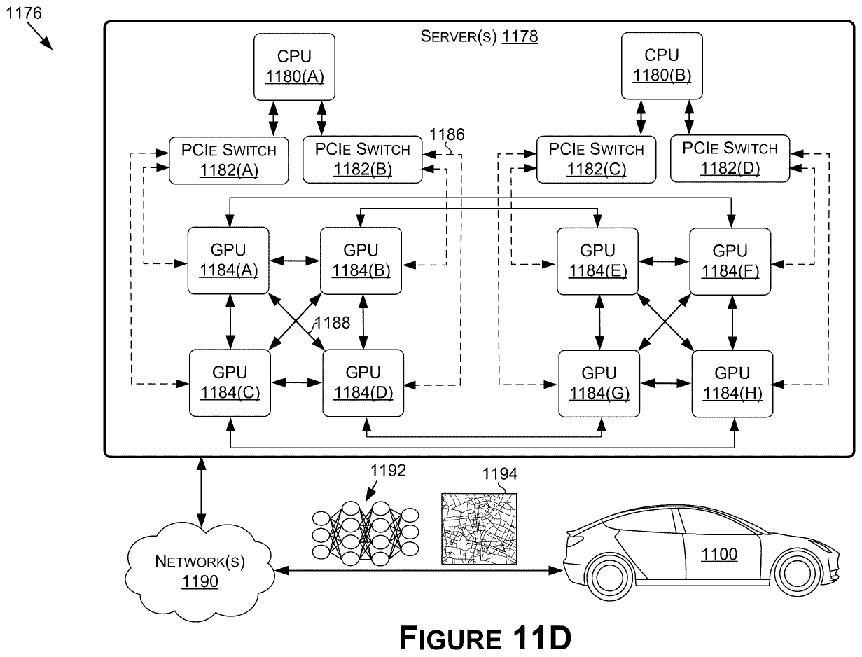

Systems and methods are disclosed related to automatic hazard detection and reporting using multi-modal models. Although the present disclosure may be described with respect to an example autonomous or semi-autonomous vehicle or machine 1100 (alternatively referred to herein as “vehicle 1100,” “ego-vehicle 1100,” “ego-machine 1100,” or “machine 1100,” an example of which is described with respect to FIGS. 11A-11D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to determining and reporting information associated with hazards, this is not intended to be limiting, and the systems and methods described herein may be used in augmented reality, virtual reality, mixed reality, robotics, security and surveillance, autonomous or semi-autonomous machine applications, and/or any other technology spaces where determining and reporting information associated with hazards may be used.

For instance, a system(s) may obtain sensor data using one or more sensors of a machine—such as a vehicle, a semi-autonomous vehicle, an autonomous vehicle, and/or other type of robot—navigating within an environment. As described herein, the sensor data may include, but is not limited to, image data obtained using one or more image sensors, LiDAR data obtained using one or more LiDAR sensors, RADAR data obtained using one or more RADAR sensors, location data obtained using one or more location sensors, audio data obtained using one or more microphones, input data obtained using one or more input sensors (e.g., a touch-sensitive display, etc.), and/or any other type of sensor data obtained using any other type of sensor. The system(s) may then process at least a portion of the sensor data to determine whether a hazard is potentially located within the environment and/or determine information associated with a hazard that is located within the environment.

As described herein, a hazard may include, but is not limited to, a driving surface being obstructed (e.g., from an object, such as a pedestrian, an animal, a vehicle, and/or any other type of object, and/or from a collision), an object located near the driving surface, the presence of emergency services and/or personnel, road construction, a dangerous driving condition (e.g., a gravel road, a pothole, etc.), dangerous drivers, and/or any other type of hazard that may change a way that a driver, a semi-autonomous vehicle, and/or an autonomous vehicle navigates. Additionally, information associated with a hazard may describe, but is not limited to, a type of hazard, a location of the hazard, a wait condition created from the hazard (e.g., whether a lane is blocked, an amount of time to navigate around the hazard, etc.), any potential updates with regard to the hazard (e.g., if the hazards has already been reported), a number of objects (e.g., vehicles, emergency personal, etc.) associated with the hazard, one or more types of the object(s) associated with the hazard, and/or any other information that describes the hazard.

For a first example, if a hazard includes a collision between two vehicles, then the system(s) may determine information that describes the type of hazard is a collision, the number of vehicles involved, whether the vehicles are blocking one or more lanes, and/or any other information associated with the collision. For a second example, if a hazard includes a police officer making a traffic stop, then the system(s) may determine information that describes the type of hazard is a traffic stop, the number of police vehicles and/or officers involved, the side of the driving surface for which the traffic stop is occurring, and/or any other information associated with the traffic stop. Still, for a third example, if a hazard includes an obstruction in a lane of traffic, then the system(s) may determine information that describes the type of hazard is an obstructed lane, the type of object that is causing the obstruction, the lane that is obstructed, and/or any other information associated with the obstruction.

As described herein, the system(s) may use one or more techniques to determine the information associated with hazards using the sensor data. For instance, in some examples, the system(s) may input at least a portion of the sensor data into one or more machine learning models (the hazard model(s)), such as one or more language models, one or more vision-language models, one or more text-to-speech models, one or more speech-to-text models, and/or any other type of model. For instance, the system(s) may input, into the hazard model(s), at least image data representing one or more images depicting the environment at least partially surrounding the machine. Additionally, in some examples, the system(s) input additional data into the hazard model(s), such as prompt data representing one or more prompts associated with identifying hazards. As described herein, in some examples, a prompt may include a general prompt, such as to identify any hazards that are located proximate to the machine. Additionally, or alternatively, in some examples, a prompt may include a specific prompt, such as to identify a specific type of hazard (e.g., a collision) located proximate to the machine. In any of the examples, based at least on processing the inputted data, the hazard model(s) may generate and/or output data representing information associated one or more hazards that are potentially located proximate to the machine.

In some examples, the system(s) may be configured to process the input data using one or more iterations in order to identify the information associated with a hazard. For a first example, the system(s) may initially input the input data (e.g., the sensor data, etc.) along with a first prompt into the hazard model(s), where the first prompt is associated with generally identifying hazards. If the output data from the hazard model(s) then indicates that a hazard is located within the environment, the system(s) may input at least a portion of the input data, the output data, and a second prompt that is more specific into the hazard model(s). For example, the second prompt may be associated with identifying a type of hazard and/or a location of the hazard. As such, the hazard model(s) may then generate additional output data that provides more details about the hazard, such as the type of hazard and/or the location of the hazard. This process may then repeat for any number of iterations such that the system(s) receives additional information associated with the hazard.

For a second example, the system(s) may initially input the input data along with a first prompt into the hazard model(s), where the first prompt is associated with a first type of hazard. For instance, the first prompt may be associated with identifying collisions within the environment, such as by including “Determine if there is a collision located within the environment.” The system(s) may also input the input data along with a second prompt into the hazard model(s), where the second prompt is associated with a second type of hazard. For instance, the second prompt may be associated with identifying emergency vehicles within the environment, such as by including “Identify any emergency vehicles that are located within the environment.” The system(s) may then use all of the outputs from the hazard model(s) to determine whether a hazard is located within the environment and/or determine the information associated with the hazard. For instance, a first output may indicate that there is no collision within the environment while a second output may indicate that there is an emergency vehicle located within the environment.

In some examples, the hazard model(s) may be fine-tuned to identify hazards and/or one or more types of hazards. For example, the hazard model(s) may be trained to identify collisions, emergency vehicles, and/or any other type of hazard within the environment. In some examples, the hazard model(s) may include a general model that is used to perform various tasks beyond just detecting hazards. In such examples, the system(s) may use the prompts to guide the hazard model(s) to perform the tasks described herein, such as identifying hazards, generating information associated with hazards, and/or reporting hazards.

In some examples, the system(s) may use one or more additional models (e.g., the reporting model(s))—such as one or more language models (and/or any other type of model)—to determine how to report the information associated with the hazards. For instance, the system(s) may input the output data from the hazard model(s) into the reporting model(s). Based at least on processing the output data, the reporting model(s) may then generate output data representing one or more techniques associated with reporting the information. For example, the output data may represent a request to verify the information, a request for additional information associated with the hazard, a request to provide the information, and/or any other type of request. The system(s) may then perform one or more operations using the output data.

For a first example, if the output data from the reporting model(s) represents a request to verify the information, then the system(s) may provide content representing the request. As described herein, content may include, but is not limited to, audio content representing speech, visual content representing text and/or graphics, and/or any other type of content. The system(s) may then receive an input from the user—such as audio data representing speech, input data representing a selection, input data representing text, and/or any other type of input—and use the input to determine whether to verify the information. For example, if the input indicates that the information is correct, then the system(s) may verify the information associated with the hazard. However, if the input indicates that the information is incorrect, then the system(s) may not verify the information associated with the hazard and/or request additional information from the user.

For a second example, if the output data from the reporting model(s) represents a request for additional information associated with the hazard, then the system(s) may again provide content representing the request. Additionally, the system(s) may receive input representing the additional information associated with the hazard. For example, the input may include audio data representing speech that describes the hazard, such as the type of hazard and/or the location of the hazard. The system(s) may then use the input to update the information associated with the hazard. In some examples, updating the information may include using the hazard model(s), the reporting model(s), and/or any other type of model to process the input in order to generate output data representing the updated information.

In some examples, the system(s) may use outputs from one or more other processing components of the machine—such as one or more systems, one or more classifiers, one or more machine learning models, one or more neural networks, one or more modules, one or more software applications, one or more hardware processors, and/or the like—to determine information associated with hazards. For a first example, if the output from the hazard model(s) indicates that a hazard includes an emergency vehicle, then the system(s) may process at least a portion of the sensor data (e.g., audio data, etc.) using one or more processing components that are configured to determine types of emergency vehicles. This way, the system(s) may use the hazard model(s) to determine initial information associated with the hazard, such as that an emergency vehicle is located within the environment, and the processing component(s) to determine additional information, such as a type of the emergency vehicle. For a second example, if the output from the hazard model(s) indicates that a hazard includes an obstruction, the system(s) may process at least a portion of the sensor data (e.g., image data, RADAR data, LiDAR data, etc.) using one or more processing components (e.g., one or more perception systems) that are configured to determine information associated with objects. This way, the system(s) may use the hazard model(s) to determine initial information associated with the hazard, such as that the hazard includes an obstruction and/or a type of object causing the obstruction, and the processing component(s) to determine additional information, such as a location of the object within the environment.

The system(s) may then perform one or more processes using the information associated with hazards. For instance, in some examples, the system(s) may send data representing at least a portion of the information to one or more additional systems (the application system(s)). As described herein, the application system(s) may be associated with providing information associated with hazards to users. For instance, the application system(s) may generate, manage, and/or update an application that provides user interfaces displaying information about hazards located within environments. For example, and for a hazard, a user interface may display at least a type of hazard, a location of the hazard within the environment, and/or any other details that are relevant to the hazard. As such, the application system(s) may use the received data to update one or more user interfaces to include at least a portion of the information associated with the hazards. This way, other users of the application are able to use the user interface(s) to identify information associated with the hazards and/or take precautions based on the information, such as changing driving actions and/or taking new routes.

Additionally, or alternatively, in some examples, the system(s) may use information associated with hazards to determine one or more operations for the machine to perform. For a first example, the system(s) may cause the machine to output content corresponding to a hazard, such as audio content indicating the information associated with the hazard, visual content displaying the information associated with the hazard, and/or any other type of content. For a second example, such as when the machine is semi-autonomous and/or autonomous, the system(s) may determine one or more trajectories that the machine should navigate in order to avoid the hazard and/or safely navigate by the hazard. The system(s) may then cause the machine to perform at least one trajectory. Still, for a third example, the machine may notify a user to contact emergency services and/or may automatically contact emergency services based on the information. In such examples, the machine may also send at least a portion of the information to the emergency services so that the emergency services may determine the hazard that is occurring. While these are just a few example operations that may be performed using the information associated with hazards, in other examples, the system(s) may cause the machine to perform additional and/or alternative operations.

While the examples herein describe identifying hazards, determining information associated with hazards, and/or providing the information associated with the hazards (e.g., such to update an application), in other examples, similar processes may be used to report information for other types of objects and/or features within environments.

In some examples, models (e.g., machine learning models, deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs) - which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Additionally, in some embodiments, the systems and methods described herein may be performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of the underlying algorithms, systems, and/or processes prior to deploying them in the real-world. In some instances, the simulation may be used to generate synthetic training data—e.g., training data including hazards, landmarks, features, objects, etc.—so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to identify information associated with hazards within the environment, wherein the information may then be included in a visualization or mapping of an environment to aid a remote operator in controlling—or providing waypoints or other indications of control or navigation—an autonomous or semi-autonomous machine through an environment. For example, information relating to hazards may be provided (e.g., via a visualization) to a remote operator to aid the remote operator in making navigation, planning, and/or control decisions for the (at least partially) remotely controlled vehicle or machine.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

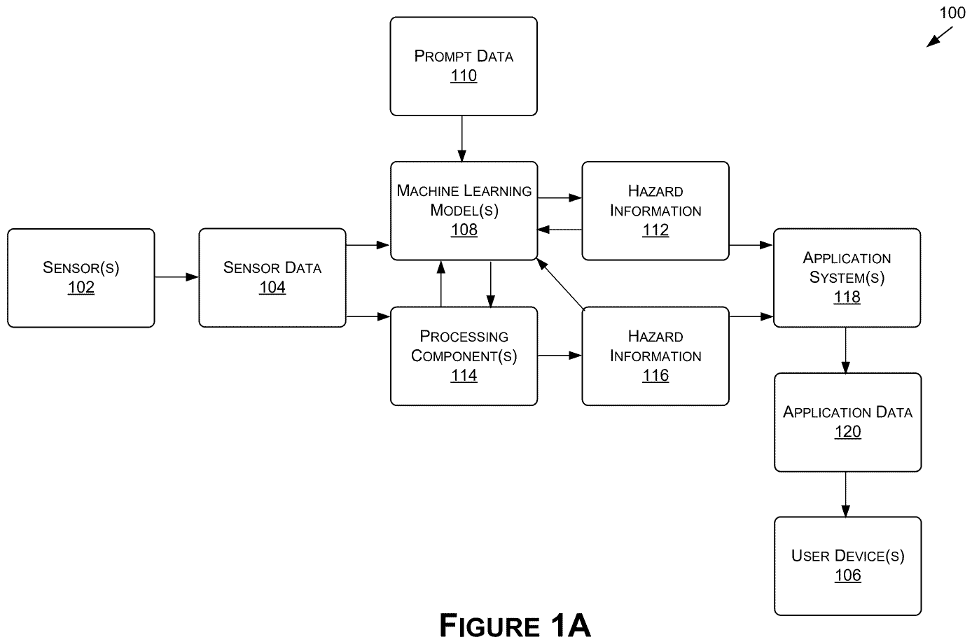

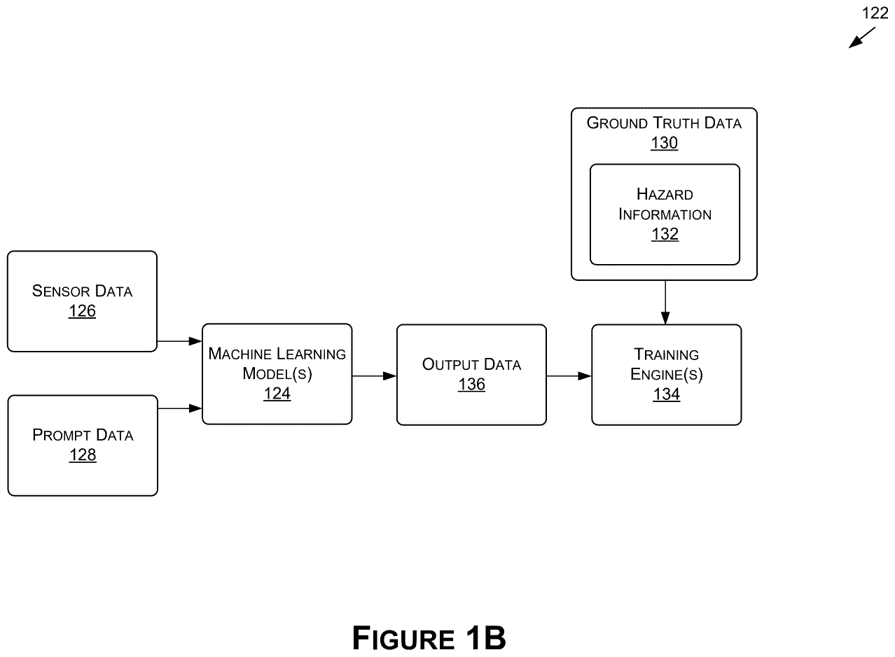

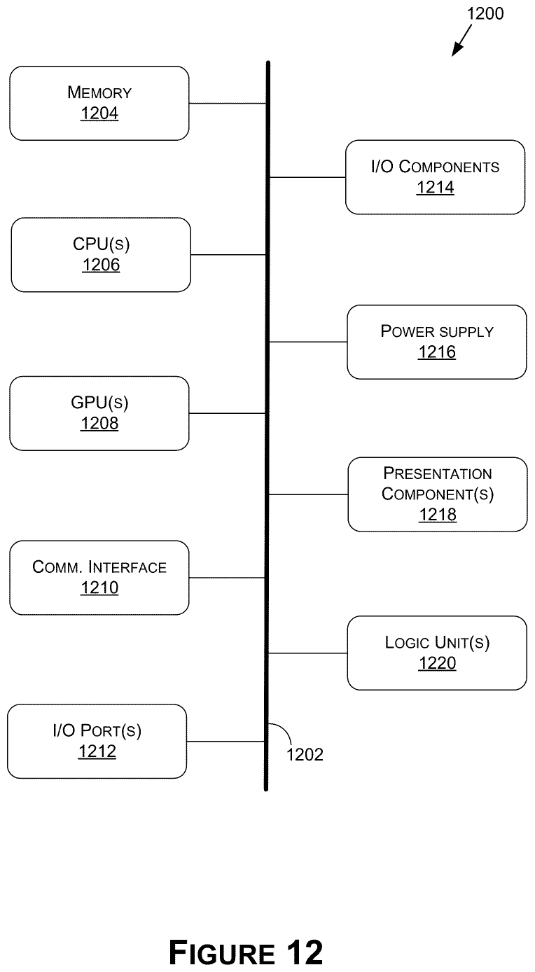

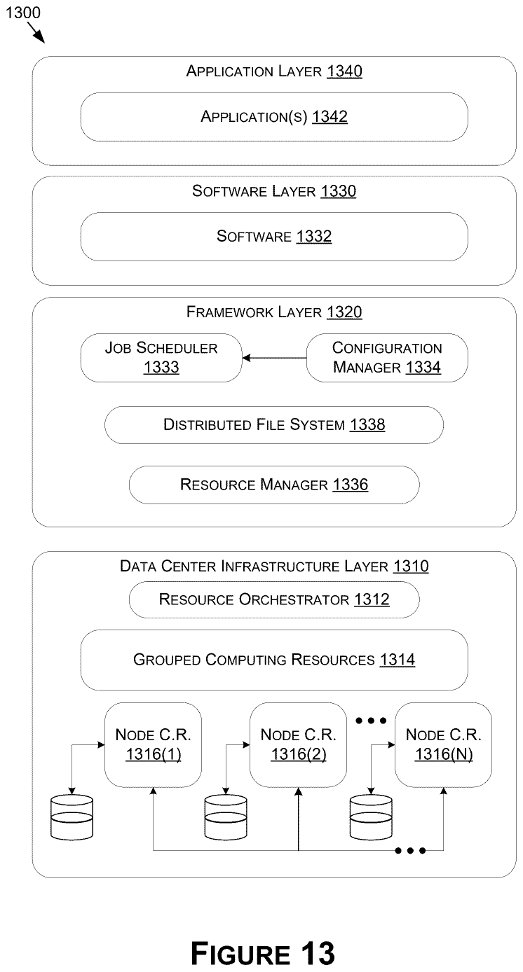

With reference to FIG. 1A, FIG. 1A illustrates an example data flow diagram for a process 100 of automatically determining and/or providing information associated with hazards, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1100 of FIGS. 11A-11D, example computing device 1200 of FIG. 12, and/or example data center 1300 of FIG. 13.

For instance, the process 100 may include one or more sensors 102 generating sensor data 104. As described herein, the sensor data 104 may include, but is not limited to, image data obtained using one or more image sensors, LiDAR data obtained using one or more LiDAR sensors, RADAR data obtained using one or more RADAR sensors, location data obtained using one or more location sensors, audio data obtained using one or more microphones, input data obtained using one or more input sensors (e.g., a touch-sensitive display, etc.), and/or any other type of sensor data obtained using any other type of sensor. In some examples, the sensor(s) 102 may be included as part of and/or be associated with a machine. For example, the sensor(s) 102 may be included as part of a vehicle, a semi-autonomous vehicle, and/or an autonomous vehicle (e.g., an example autonomous vehicle 1102) that is navigating within an environment. Additionally, or alternatively, in some examples, the sensor(s) 102 may be included as part of one or more user devices 106. For example, the sensor(s) 102 may be part of a user device 106 associated with an occupant of the machine.

As described herein, the sensor data 104 may represent one or more hazards located within the environment. In some examples, a hazard may include, but is not limited to, a driving surface being obstructed (e.g., from an object, such as a pedestrian, an animal, a vehicle, and/or any other type of object, and/or from a collision), an object located near the driving surface, the presence of emergency services and/or personnel, road construction, a dangerous driving condition (e.g., a gravel road, a pothole, etc.), dangerous drivers, and/or any other type of hazard that may change a way that a driver, a semi-autonomous vehicle, and/or an autonomous vehicle navigates. For a first example, a hazard may include an object—such as a pedestrian, an animal, a vehicle, and/or any other type of object—located within at least one lane of a driving surface. For a second example, a hazard may include an emergency vehicle—such as a police car, an ambulance, and/or the like—located on a driving surface and/or proximate to the driving surface. For a third example, a hazard may include a pothole that is located in the driving surface.

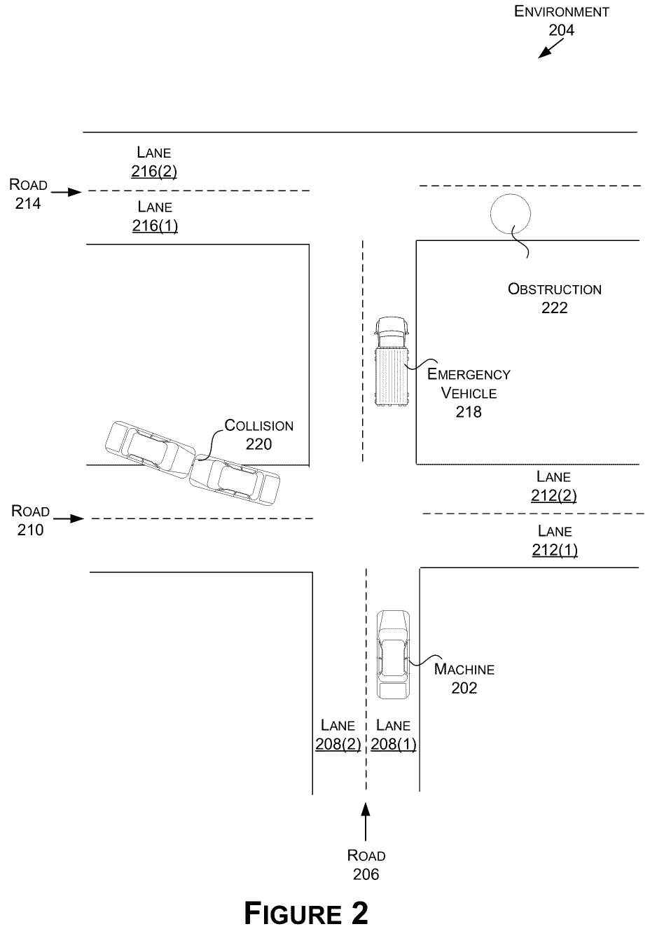

For instance, FIG. 2 illustrates an example of a machine 202 navigating within an environment 204 that includes multiple hazards, in accordance with some embodiments of the present disclosure. As shown, the environment 204 may include at least a first road 206 with two lanes 208(1)-(2), a second road 210 with two lanes 212(1)-(2), and a third road 214 with two lanes 216(1)-(2), where the machine 202 is navigating withing the first lane 208(1) of the first road 206. While navigating, the machine 202 may generate sensor data (which may include, and/or be similar to, the sensor data 104) representing the multiple hazards. For instance, a first hazard may be associated with an emergency vehicle 218 located on the first road 206, a second hazard may be associated with a collision 220 between two vehicles on the second road 210, and a third hazard may be associated with an obstruction 222 located on the third road 214.

Referring back to the example of FIG. 1A, the process 100 may include inputting at least a portion of the sensor data 104 into one or more machine learning models 108 (model(s) 108), such as one or more language models, one or more vision-language models, one or more text-to-speech models, one or more speech-to-text models, and/or any other type of model. For example, if the model(s) 108 includes the vision-language model(s), then the process 100 may include inputting at least image data representing one or more images of the environment into the model(s) 108. As shown, the process 100 may further include inputting additional data into the model(s) 108, such as prompt data 110 representing one or more prompts that are configured to guide the model(s) 108 to perform one or more tasks. For example, the prompt(s) may be associated with guiding the model(s) 108 to identify hazards within the environment and/or determine information associated with the identified hazards.

For instance, in some examples, a prompt may include a general prompt that guides the model(s) 108 to perform a general task associated with identifying hazards. For a first example, a prompt may guide the model(s) 108 to identify one or more hazards using at least the sensor data 104. For instance, a prompt may include “Do you see one or more hazards within the environment” or “Do you see a collision, an emergency vehicle, debris, or animals within the environment.” For a second example, a prompt may guide the model(s) 108 to generate information associated with an identified hazard. For instance, a prompt may include “Please provide information about any identified hazard within the environment.”

Additionally, or alternatively, in some examples, a prompt may include a specific prompt that guides the model(s) 108 to perform a specific task associated with identifying hazards. For a first example, a prompt may guide the model(s) 108 to identify a specific type of hazard, such as emergency vehicles located on a driving surface. For instance, a prompt may include “Do you see a vehicle stopped on the road,” “Is there any debris on the road,” or “Do you see an emergency vehicle located within the environment.” For a second example, a prompt may guide the model(s) 108 to generate specific information associated with a hazard, such as information describing a location associated with the hazard as represented by one or more sensor representations of the sensor data 104. For instance, a prompt may include “Can you provide us with a location of the vehicle on the road” or “Can you determine the type of emergency vehicle that is located on the road.”

Additionally, or alternatively, in some examples, the prompts may include multiple prompts that are input into the model(s) 108 in a series in order to guide the model(s) 108 to perform various tasks, which is described in more detail herein.

The process 100 may include the model(s) 108 processing the sensor data 104 and/or the prompt data 110 and, based at least on the processing, generating and/or outputting data representing hazard information 112 associated with one or more potential hazards located within the environment. In some examples, hazard information 112 associated with a hazard may describe, but is not limited to, a type of hazard, a location of the hazard, a wait condition created from the hazard (e.g., whether a lane is blocked, an amount of time to navigate around the hazard, etc.), any potential updates with regard to the hazard (e.g., if the hazards has already been reported), a number of objects (e.g., vehicles, emergency personal, etc.) associated with the hazard, one or more types of the object(s) associated with the hazard, and/or any other information that describes the hazard. Additionally, a type of hazard may include an obstruction located on a driving surface, a collision, an emergency vehicle, construction, a dangerous driving condition, dangerous drivers, and/or any other type of hazard. Furthermore, a location of hazard may include a general location within the environment—such as the x-coordinate location, the y-coordinate location, and/or z-coordinate location, a driving surface, a lane, a shoulder of the driving surface, and/or the like—a specific location associated with a sensor representation (e.g., an image)—such as a bounding shape (e.g., bounding box, etc.) indicating a portion of the sensor representation that represents the hazard—and/or any other type of location information.

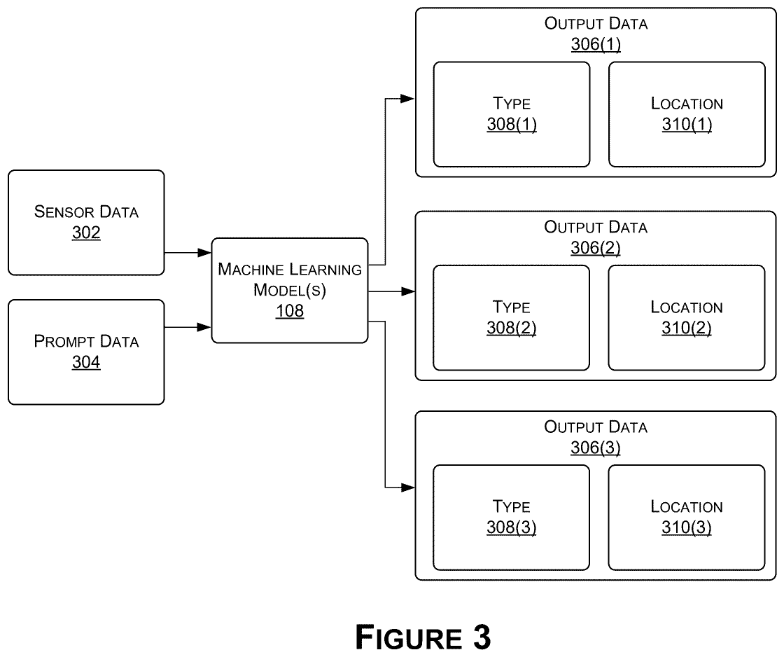

For instance, FIG. 3 illustrates an example of using the model(s) 108 to determine information associated with hazards, in accordance with some embodiments of the present disclosure. As shown, sensor data 302 obtained using one or more sensors of the machine 202 along with prompt data 304 representing one or more prompts may be input into the model(s) 108. The model(s) 108 may then process the data and, based at least on the processing, generate output data 306(1)-(3) associated with the hazards within the environment 204. For instance, and as shown, the first output data 306(1) may represent information associated with the first hazard, such as that a first type 308(1) of the first hazard includes the emergency vehicle 218 and a first location 310(1) associated with the first hazard. In some examples, the first location may indicate the location of the first hazard within the environment 204 (e.g., coordinates, the first road 206, the first lane208(1), etc.) and/or a location within a sensor representation that represents the first hazard.

Additionally, the second output data 306(2) may represent information associated with the second hazard, such as that a second type 308(2) of the second hazard includes the collision 220 and a second location 310(2) associated with the second hazard. In some examples, the second location may indicate the location of the second hazard within the environment 204 (e.g., coordinates, the second road 210, the second lane 212(2), etc.) and/or a location within a sensor representation that represents the second hazard. Furthermore, the third output data 306(3) may represent information associated with the third hazard, such as that a third type 308(3) of the third hazard includes the obstruction 222 and a third location 310(3) associated with the third hazard. In some examples, the third location may indicate the location of the third hazard within the environment 204 (e.g., coordinates, the third road 214, the first lane 216(1), etc.) and/or a location within a sensor representation that represents the third hazard.

Referring back to the example of FIG. 1A, in some examples, the process 100 may include processing the input data using one or more iterations in order to identify the hazard information 112 associated with a hazard. For a first example, the sensor data 104 along with a first prompt may initially be input into the model(s) 108, where the first prompt is associated with generally identifying hazards. If the hazard information 112 generated using the model(s) 108 then indicates that a hazard is located within the environment, the sensor data 104 (and/or additional sensor data 104), data representing the hazard information 112, and a second prompt that is more specific may be input into the model(s) 108. For example, the second prompt may be associated with identifying a type of the hazard and/or a location of the hazard. As such, the model(s) 108 may then generate additional hazard information 112 that provides more details about the hazard, such as the type of hazard and/or the location of the hazard. This process 100 may then repeat for any number of iterations such that the model(s) 108 continues generating additional hazard information 112 associated with the hazard.

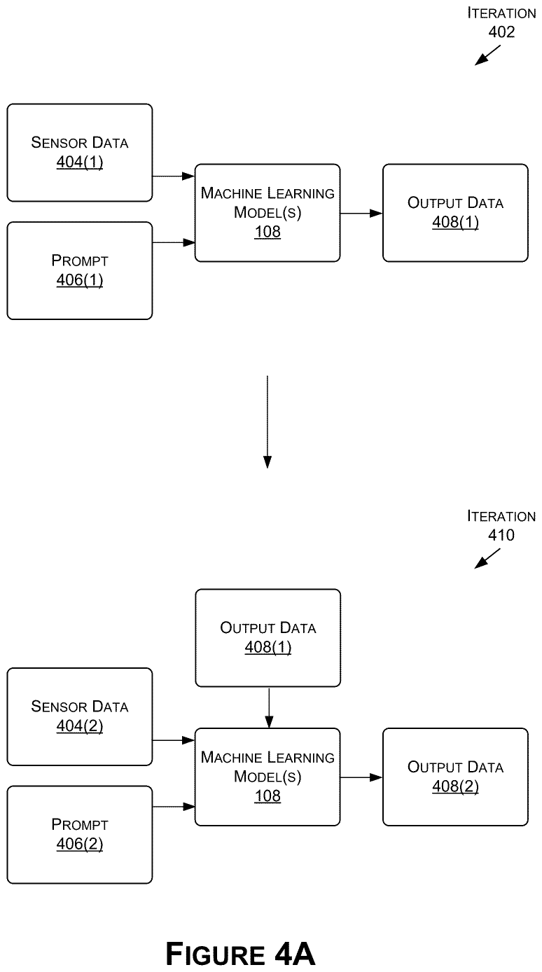

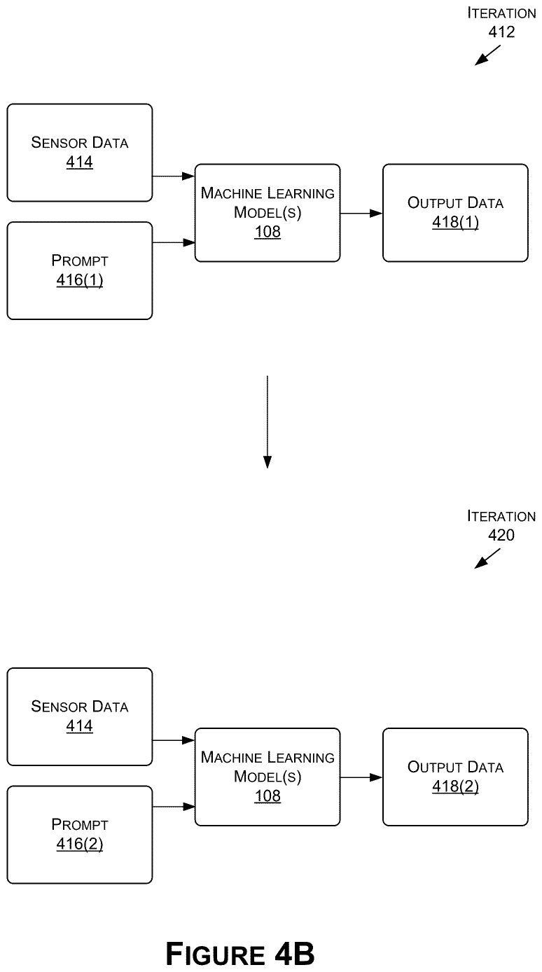

For instance, FIG. 4A illustrates an example of processing input data using one or more iterations to determine information associated with a hazard, in accordance with some embodiments of the present disclosure. As shown, during a first iteration 402, first sensor data 404(1) obtained using one or more sensors of the machine 202 along with a first prompt 406(1) may be input into the model(s) 108. In some examples, the first prompt 406(1) may include a general prompt that guides the model(s) 108 to determine whether the first sensor data 404(1) represents one or more hazards located within the environment, such as by including “Determine if there are any hazards represented by the images.” Based at least on processing the data, the model(s) 108 may generate first output data 408(1) indicating whether one or more of the hazards are located within the environment. For example, the first output data 408(1) may indicate that the first hazard associated with the emergency vehicle 218 is located within the environment 204.

Next, during a second iteration 410, second sensor data 404(2) (which may include, or be different than, the first sensor data 404(1)), a second prompt 406(2), and the first output data 408(1) may be input into the model(s) 108. In some examples, the second prompt 406(2) may include a specific prompt that guides the model(s) 108 to perform a specific task, such as to identify the type of hazard and/or identify the location of the hazard. As such, based on processing the data, the model(s) 108 may generate second output data 408(2) indicating the type of the first hazard - such as the emergency vehicle 218—and/or the location associated with the first hazard. In some examples, this process may repeat for one or more additional iterations, where each iteration uses a different prompt to guide the model(s) 108 to determine additional information associated with hazards.

Referring back to the example of FIG. 1A, in some examples, the process 100 may include inputting multiple prompts into the model(s) 108 to perform multiple tasks. For instance, the process 100 may include initially inputting the sensor data 104 along with a first prompt into the model(s) 108, where the first prompt is associated with a first type of hazard. For instance, the first prompt may be associated with identifying collisions within the environment, such as by including “Determine if there is a collision located within the environment.” Additionally, the model(s) 108 may generate first hazard information 112 associated with the first type of hazard. The process 100 may also include inputting the sensor data 104 along with a second prompt into the model(s) 108, where the second prompt is associated with a second type of hazard. For instance, the second prompt may be associated with identifying emergency vehicles within the environment, such as by including “Identify any emergency vehicles that are located within the environment.” Additionally, the model(s) 108 may generate second hazard information 112 associated with the second type of hazard.

For instance, FIG. 4B illustrates an example of processing input data using one or more iterations associated with one or more prompts, in accordance with some embodiments of the present disclosure. As shown, during a first iteration 412, sensor data 414 obtained using one or more sensors of the machine 202 along with a first prompt 416(1) may be input into the model(s) 108. In some examples, the first prompt 416(1) may be associated with performing a specific task, such as identifying a specific type of hazard. For example, the first prompt 416(1) may be associated with identifying emergency vehicles within the environment 204. As such, based on processing the data, the model(s) 108 may generate first output data 418(1) representing information associated with the first hazard associated with the emergency vehicle 218.

Additionally, during a second iteration 412, the sensor data 414 obtained using the one or more sensors of the machine 202 along with a second prompt 416(2) may be input into the model(s) 108. In some examples, the second prompt 416(2) may be associated with performing a specific task, such as identifying a specific type of hazard. For example, the second prompt 416(2) may be associated with identifying collisions within the environment 204. As such, based on processing the data, the model(s) 108 may generate second output data 418(2) representing information associated with the second hazard associated with the collision 220. This way, different prompts may be used to guide the model(s) 104 to perform different tasks associated with reporting hazards within the environment 202.

Referring back to the example of FIG. 1A, some examples, the process 100 may including using one or more additional models 108—such as one or more language models (and/or any other type of model)—to determine how to report the hazard information 112 associated with the hazards. For instance, the additional model(s) 108 may process data representing at least a portion of the hazard information 112. Based at least on processing the data, the additional model(s) 108 may generate output data representing one or more techniques associated with reporting the hazard information 112. For example, the output data may represent a request to verify the hazard information 112, a request for additional hazard information 112 associated with the hazard, a request to provide the hazard information 112, and/or any other type of request. The process 100 may then include performing one or more operations based at least on the reporting determined using the additional model(s) 108.

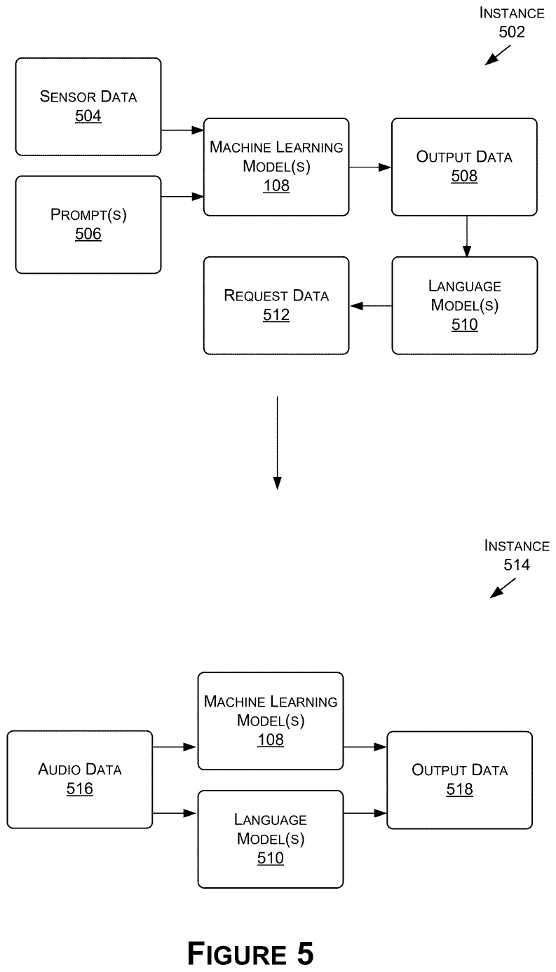

For more details, FIG. 5 illustrates an example of using speech to determine information associated with a hazard, in accordance with some embodiments of the present disclosure. As shown, during a first instance, sensor data 504 obtained using one or more sensors of the machine 202 along with one or more prompts 506 may be input into the model(s) 108. Based at least on processing the data, the model(s) 108 may generate output data 508 representing information associated with a hazard. For example, the output data 508 may represent text describing the hazard. One or more language models 510 (one or more text-to-speech models, one or more speech-to-text models, one or more large language models, etc.) may then process the output data 508 in order to determine how to report the information. For instance, the language model(s) 510 may generate request data 512 representing a request to confirm the information associated with the hazard, a request to provide additional information associated with the hazard, and/or any other type of request.

The machine 202 may then provide the request to one or more users of the machine 202. For example, the machine 202 may output audio content representing the request, display visual content that includes text corresponding to the request, send the request data 512 to a user device for presentation to the user(s), and/or use any other technique.

Next, and at a second instance 514, the machine 202 may use one or more sensors (e.g., one or more microphones) to obtain audio data 516 representing user speech corresponding to the request. For instance, the user speech may verify the information—such as “The information associated with the hazard is correct”—indicate the requested information—such as “The first hazard includes an ambulance located in the first lane 208(1) of the first road 206”—and/or provide any other details about the hazard. The model(s) 108 and/or the language model(s) 510 may then process the audio data 516 in order to generate additional output data 518 associated with the hazard. For a first example, if the speech indicates that the information is correct, then the additional output data 518 may represent the information determined by the model(s) 108 as represented by the output data 508. For a second example, if the speech indicates additional information associated with the hazard, then the additional output data 518 may represent the additional information indicated by the speech and/or the information represented by the output data 508.

In some examples, the processes described in the example of FIG. 5 may repeat for additional iterations. For instance, the model(s) 108 and/or the language model(s) 510 may process the additional output data 518 in order to determine whether further information associated with the hazard should be requested. If the model(s) 108 and/or the language model(s) 510 determines that further information should be requested, then another request may be provided for the further information. Additionally, the model(s) 108 and/or the language model(s) 510 may process additional audio data representing additional speech that indicates this further information. In other words, these processes may continue to repeat until the model(s) 108 and/or the language model(s) 510 determines that there is sufficient information associated with the hazard.

Referring back to the example of FIG. 1A, the process 100 may include processing at least a portion of the sensor data 104 using one or more processing components 114 associated with the machine to determine additional hazard information 116 associated with hazards. As described herein, a processing component 114 may include, but is not limited to, a machine learning model, a neural network, a classifier, an algorithm, a module, software, hardware, and/or any other type of processing component. For example, a processing component 114 may include a perception system, a location system, a trajectory system, a tracking system, and/or any other type of system associated with the machine.

For a first example of determining additional hazard information 116, a processing component 114 may be configured to identify different types of sensors, such as police sirens, ambulance sirens, and/or any other type of emergency response vehicle sirens. As such, the processing component 114 may process at least a portion of the sensor data 104—such as audio data representing a sound of a siren—in order to generate hazard information 116 representing the type of siren and/or the type of emergency vehicle associated with the type of siren. The hazard information 116 may then be (1) processed by the model(s) 108 to help further guide the model(s) 108 to generate the hazard information 112 and/or (2) added to the hazard information 112 to provide more details about the hazard.

For a second example, a processing component 114 may be configured process sensor data 104—such as image data, RADAR data, LiDAR data, and/or any other type of sensor data—to determine information associated with objects located within the environment. For instance, the processing component 114 may include and/or be associated with a perception system of the machine. As such, based at least on processing at least a portion of the sensor data 104, the processing component 114 may generate hazard information 116 representing information associated with one or more objects corresponding to a hazard, such as one or more types of the object(s) involved in the hazard, one or more locations of the object(s), and/or any other information associated with the object(s). The hazard information 116 may then be (1) processed by the model(s) 108 to help further guide the model(s) 108 to generate the hazard information 112 and/or (2) added to the hazard information 112 to provide more details about the hazard.

For a third example, a processing component 114 may be configured to analyze sensor data 104—such as location data, image data, RADAR data, LiDAR data, and/or any other type of sensor data—to determine pose information associated with the machine. For instance, the processing component 114 may include and/or be associated with a location system of the machine. As such, based at least on processing the sensor data 104, the processing component 114 may generate hazard information 116 representing the pose of the machine within the environment, such as the location (e.g., the x-coordinate location, the y-coordinate location, and/or the z-coordinate location) and/or orientation (e.g., the roll, the pitch, and/or the yaw) of the machine. The hazard information 116 may then be (1) processed by the model(s) 108 to help further guide the model(s) 108 to generate the hazard information 112 and/or (2) added to the hazard information 112 to provide more details about the hazard.

The process 100 may then include performing one or more operations using the hazard information 112 (and/or the hazard information 116). For instance, and as shown, the process 100 may include providing the hazard information 112 (and/or the hazard information 116) to one or more application systems 118 that generate, manage, update, and/or provide an application to users, where the application may be represented by application data 120. For instance, and as described herein, the application may at least provide information about hazards that are located within an environment, where the information is provided by users of the application, emergency response personnel, city officials, authorized personnel, and/or any other entity. In some examples, information associated with a hazard may describe, but is not limited to, a type of hazard, a location of the hazard, a wait condition created from the hazard (e.g., whether a lane is blocked, an amount of time to navigate passed the hazard, etc.), any potential updates with regard to the hazard (e.g., if the hazards has already been reported), a number of objects (e.g., vehicles, emergency personal, etc.) associated with the hazard, one or more types of the object(s) associated with the hazard, and/or the like.

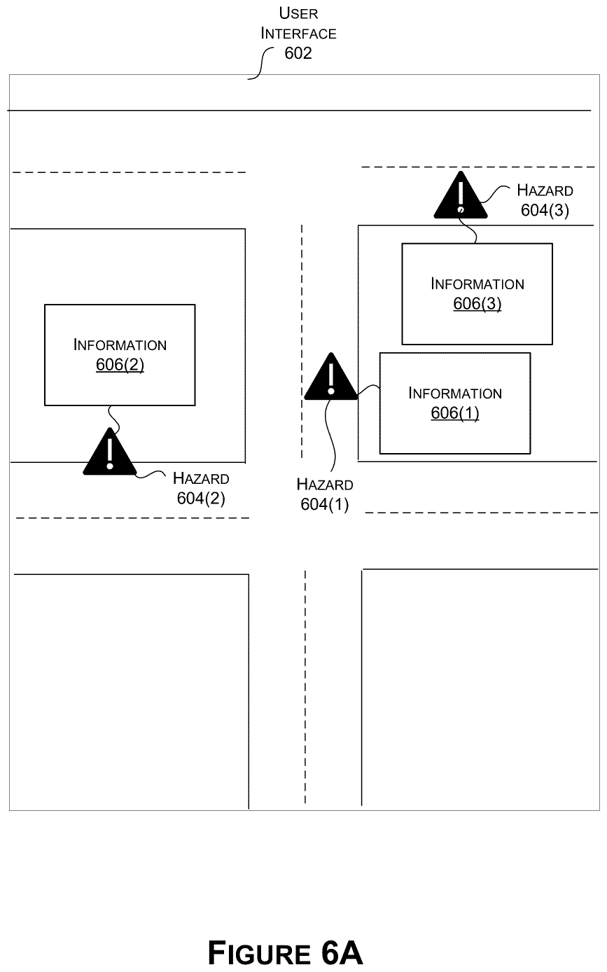

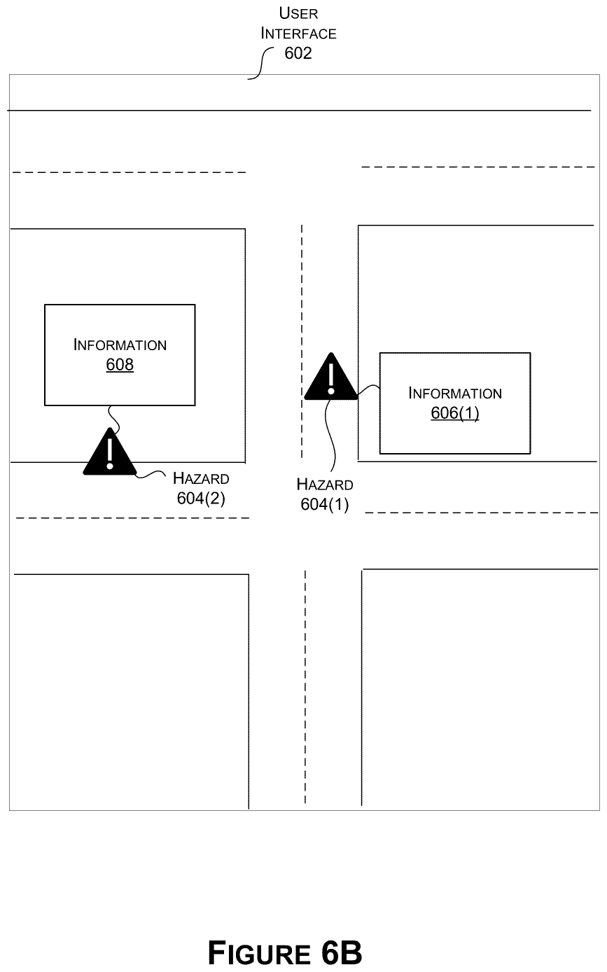

For instance, FIGS. 6A-6B illustrate an example of a user interface 602 associated with an application that provides information associated with hazards, in accordance with some embodiments of the present disclosure. As shown by the example of FIG. 6A, the user interface 602 may include at least indications 604(1)-(3) of the hazards associated with the environment 204. For example, the first indication 604(1) may indicate the first hazard associated with the emergency vehicle 218 located on the first road 206, the second indication 604(2) may indicate the second hazard associated with the collision 220 between two vehicles on the second road 210, and the third indication 604(3) may indicate the third hazard associated with the obstruction 222 located on the third road 214. As shown, the indicators 604(1)-(3) are located at approximately similar locations on a map of the environment 204 as the hazards are located within the environment 204.

The user interface 602 may further include information 606(1)-(3) respectively associated with the hazards. For example, the first information 606(1) associated with the first hazard may indicate that the emergency vehicle 218 includes an ambulance, the emergency vehicle 218 is located on the first road 206 and/or the first lane 208(1), and/or any other information associated with the first hazard. Additionally, the second information 606(2) associated with the second hazard may indicate that the second hazard includes a collision, the collision is blocking the second road 210 and/or the second lane 212(2), two vehicles are involved in the collision, and/or any other information associated with the second hazard. Furthermore, the third information 606(3) associated with the third hazard may indicate a type of the obstruction 222, the obstruction 222 is blocking the third road 214 and/or the first lane 216(1), and/or any other information associated with the third hazard. As such, by performing one or more of the processes described herein, the application system(s) 118 is able to use the hazard information determined using the model(s) 108 (and/or any other technique described herein) to update the application associated with the user interface 602.

For instance, and as shown by the example of FIG. 6B, the machine 202 and/or one or more other machines may provide updated hazard information to the application system(s) 118. For instance, the updated hazard information may indicate that the first information 606(1) associated with the first hazard is correct. As such, the application server(s) 118 may cause the user interface 602 to maintain the first information 606(1) for the first hazard. However, the updated hazard information may include updated information 608 associated with the second hazard. For instance, the updated information 608 may indicate that the vehicles have at least moved off the second road 210 such that the vehicles are no longer blocking traffic. As such, the application server(s) 118 may cause the user interface 602 to update the second information 606(2) to include the updated information 608. Furthermore, the updated hazard information may indicate that the third hazard is no longer present in the environment 204. As such, the application server(s) 118 may cause the user interface 602 to update by indicating that there is no longer the third hazard within the environment 204.

Referring back to the example of FIG. 1A, other processes may be performed with respect to the hazard information 112, the hazard information 116, and/or additional hazard information provided using the application. For instance, the machine may provide content associated with the hazard information 112 (and/or the hazard information 116 and/or the additional hazard information) to one or more users of the machine. In some examples, the content may include, but is not limited to, audio content representing speech indicating the hazard information 112 (and/or the hazard information 116 and/or the additional hazard information), visual content depicting the hazard information 112 (and/or the hazard information 116 and/or the additional hazard information), one or more warnings indicating the hazards, and/or any other type of content.

Additionally, in some examples, the machine may determine one or more operations to perform based at least on the hazard information 112 (and/or the hazard information 116 and/or the additional hazard information). For a first example, the machine may determine to reduce a speed while navigating proximate to a hazard represented by the hazard information 112. For a second example, the machine may determine a new route to navigate in order to avoid a hazard represented by the hazard information 112. Still, for a third example, the machine may notify a user to contact emergency services and/or may automatically contact emergency services based on the hazard information 112. In such examples, the machine may also send at least a portion of the hazard information 112 to the emergency services so that the emergency services may determine the hazard that is occurring. While these are just a couple example operations that may be performed by the machine using the hazard information 112, the hazard information 116, and/or the additional hazard information, in other examples, the machine may perform additional and/or alternative operations.

In some examples, the process 100 may continue to repeat as the machine continues generating the sensor data 104 using the sensor(s) 102. In some examples, the process 100 may repeat based on the occurrence of one or more events. For a first example, the process 100 may repeat at the elapse of given time intervals, such as every second (and/or other time interval). For a second example, the process 100 may repeat based on the machine determining that a potential hazard is located within the environment, such as based on the application data 120 indicating the potential hazard (e.g., reported by another user) and/or the user of the machine indicating the potential hazard. For instance, the process 100 may be performed to verify and/or update information associated with a reported hazard. For a third example, the process 100 may repeat based on a sudden change in driving conditions associated with the machine, such as the machine suddenly changing direction (e.g., turning, etc.) and/or velocity (e.g., slowing down).

As described herein, in some examples, the model(s) 108 may be trained to determine the hazard information 112 associated with hazards. For instance, FIG. 1B illustrates a data flow diagram of a process 122 for training one or more machine learning models 124 (the model(s) 124, which may include, and/or be similar to, the model(s) 108) to determine information associated with hazards, in accordance with some embodiments of the present disclosure. As shown, the model(s) 124 may be trained using training data, such as sensor data 126 (which may be similar to the sensor data 104) and prompt data 128 (which may be similar to the prompt data 110). The training data may be synthetically produced (e.g., generated from computer models or renderings), real produced (e.g., designed and produced from real-world data), and/or a combination thereof.

The model(s) 124 may be trained using the training data as well as corresponding ground truth data 130. As shown, in some examples, the ground truth data 130 may include hazard information 132 indicating whether instances of the sensor data 126 represent hazards, types of hazards representing by instances of the sensor data 126, and/or details associated with the hazards. For instances, if the sensor data 126 includes image data representing images, then individual images and/or groups of images may include corresponding ground truth data 130 representing hazard information 132.

As shown, to train the model(s) 124, one or more training engines 134 may use one or more loss functions to measure loss (e.g., error) in output data 136 as compared to the ground truth data 130. In some examples, any type of loss function may be used. Additionally, in some examples, different outputs may have different loss functions. For instance, hazard information indicating whether instances of sensor data 126 represent hazards may have a first loss function, hazard information indicating types of the hazards may have a second loss function, and/or so forth. In such examples, the loss functions may be combined to form a total loss (where one or more losses may be weighted), and the total loss may be used to train (e.g., update the parameters of) the model(s) 124. In any example, backward pass computations may be performed to recursively compute gradients of the loss function(s) with respect to training parameters. In some examples, weights and/or biases of the model(s) 124 may be used to compute these gradients.

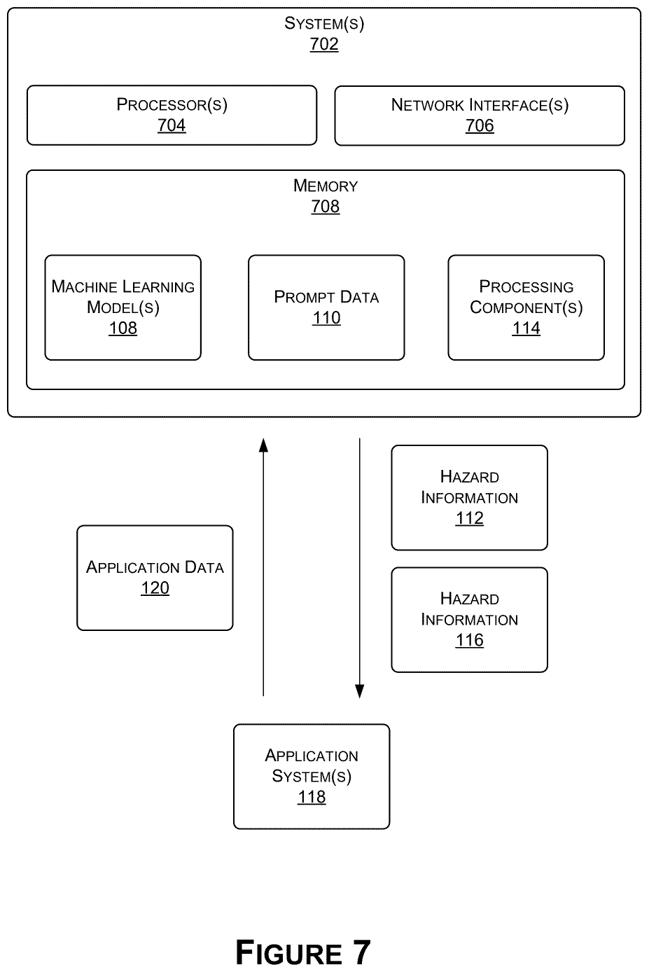

FIG. 7 illustrates an example of one or more systems 702 that are configured to perform one or more of the processes described herein, in accordance with some embodiments of the present disclosure. In some examples, at least a portion of the system(s) 702 may be included in a machine, such as an example autonomous vehicle 1100 (and/or any other type of machine). In some examples, at least a portion of the system(s) 702 may be remote from and communicate with the machine. In such examples, the system(s) 702 may receive the senor data 104 from the machine and/or send the hazard information 112 (and/or the hazard information 116) back to the machine.

As shown, the system(s) 902 may include one or more processors 704 (which may include, and/or be similar, to a CPU(s) 1108, a GPU(s) 1110, a processor 1112, a CPU(s) 1120, a GPU(s) 1120, a CPU(s) 1206, and/or a GPU(s) 1208), one or more communication interfaces 706 (which may include, and/or be similar to, a network interface 1124 and/or a communication interface(s) 1210), and memory 708 (which may include, and/or be similar to, memory 1204). The memory 708 may also store the model(s) 108, the prompt data 110, and/or the processing component(s) 114. Additionally, the processor(s) 704 may execute the model(s) 108 and/or the processing component(s) 114 to perform one or more of the processes described herein.

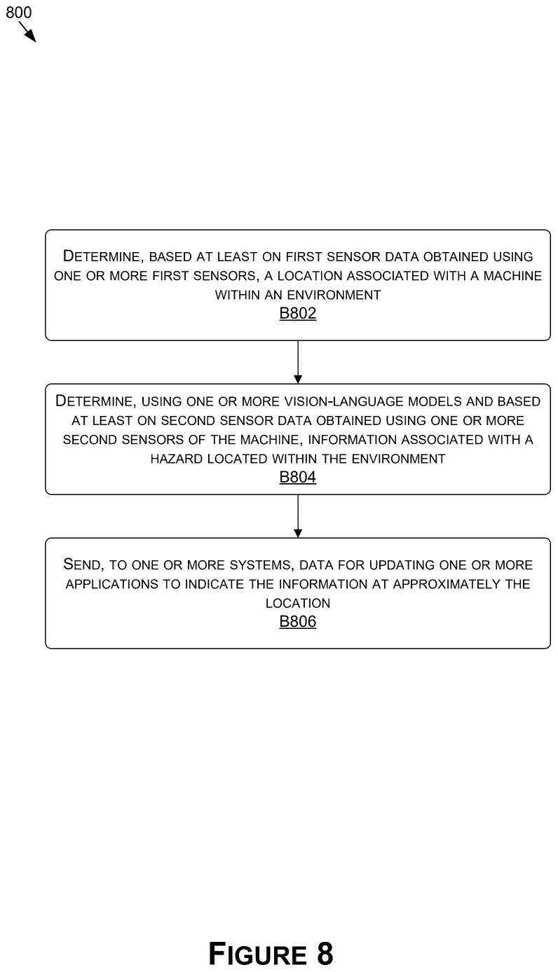

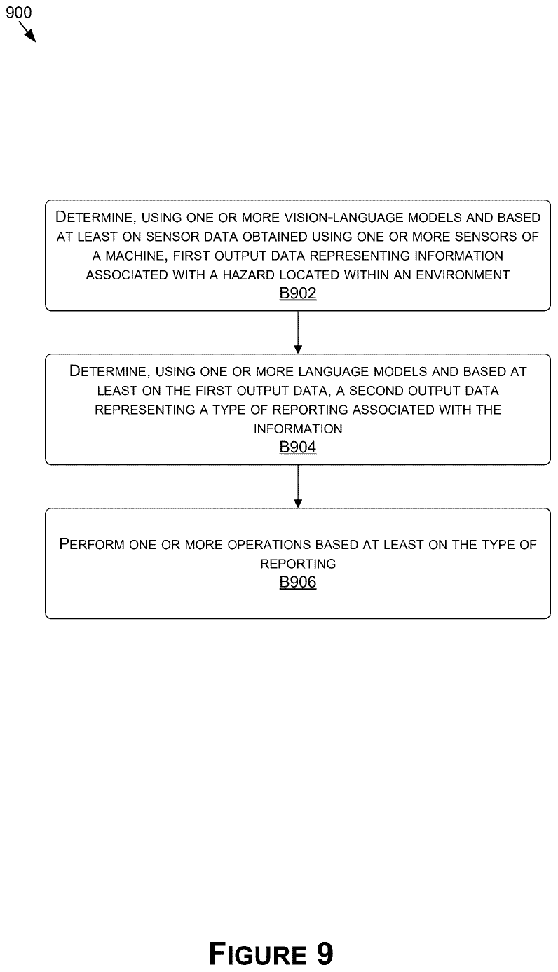

Now referring to FIGS. 8 and 9 each block of method 800 and 900, described herein, comprises a computing process that may be performed using any combination of hardware, firmware, and/or software. For instance, various functions may be carried out by a processor executing instructions stored in memory. The methods 800 and 900 may also be embodied as computer-usable instructions stored on computer storage media. The methods 800 and 900 may be provided by a standalone application, a service or hosted service (standalone or in combination with another hosted service), or a plug-in to another product, to name a few. In addition, these methods 800 and 900 described, by way of example, with respect to FIGS. 1 and 7. However, these methods 800 and 900 may additionally or alternatively be executed by any one system, or any combination of systems, including, but not limited to, those described herein.

FIG. 8 illustrates a flow diagram showing a method 800 for automatically determining and providing information associated with a hazard, in accordance with some embodiments of the present disclosure. The method 800, at block B802, may include determining, based at least on first sensor data obtained using one or more first sensors, a location associated with a machine within an environment. For instance, the system(s) 702 (e.g., the processing component(s) 114) may use the first sensor data 104 to determine the location associated with the machine. As described herein, in some examples, the first sensor data 104 is generated using the sensor(s) 102 of the machine. Additionally, or alternatively, in some examples, the first sensor data 104 is generated using the sensor(s) 102 of a user device 106.

The method 800, at block B804, may include determining, using one or more vision-language models and based at least on second sensor data obtained using one or more second sensors of the machine, information associated with a hazard located within the environment. For instance, the system(s) 702 may input the second sensor data 104 into the model(s) 108. As described herein, the second sensor data 104 may include at least image data representing one or more images of the environment. In some examples, the system(s) 702 may input additional data into the model(s) 108, such as the prompt data 110 representing one or more prompts. The model(s) 108 may then process the data and generate the hazard information 112 associated with the hazard. In some examples, the system(s) 702 may use one or more additional models 108, such as one or more language models, to verify the hazard information 112 and/or determine whether to request additional hazard information associated with the hazard.

The method 800, at block B806, may include sending, to one or more systems, data for updating one or more applications to indicate the information associated with the hazard at approximately the location. For instance, the system(s) 702 may send the data representing at least the hazard information 112 to the application system(s) 118. The application system(s) 118 may then use the data to update the application(s), such that the application(s) provides at least the hazard information 112 associated with the hazard.

FIG. 9 illustrates a flow diagram showing a method 900 for determining how to report information associated with a hazard, in accordance with some embodiments of the present disclosure. The method 900, at block B902, may include determining, using one or more vision-language models and based at least on sensor data obtained using one or more sensors of a machine, a first output data representing information associated with a hazard located within an environment. For instance, the system(s) 702 may input the sensor data 104 into the model(s) 108. As described herein, the sensor data 104 may include at least image data representing one or more images of the environment. In some examples, the system(s) 702 may input additional data into the model(s) 108, such as the prompt data 110 representing one or more prompts. The model(s) 108 may then process the input data and generate the first output data representing the hazard information 112 associated with the hazard.

The method 900, at block B904, may include determining, using one or more language models and based at least on the first output, a second output representing a type of reporting associated with the information. For instance, the system(s) 702 may input the first output into an additional model(s) 108. The language model(s) may process the first output data in order to generate the second output data representing the type of reporting. As described herein, in some examples, the type of reporting may include, but is not limited to, requesting that a user verify the hazard information 112, requesting that the user provide additional hazard information 116 associated with the hazard, providing the hazard information 112 to the application system(s) 118, and/or performing any other type of reporting.

The method 900, at block B906, may include performing one or more operations based at least on the type of reporting. For instance, the system(s) 702 may perform the operation(s) based on the type of reporting from the additional model(s) 108. For a first example, if the type of reporting includes verifying the hazard information 112, then the system(s) 702 may generate and/or provide content representing the request to verify the hazard information 112. For a second example, if the type of reporting includes requesting the additional hazard information 116, then the system(s) 702 may generate and/or provide content representing a request for the additional hazard information 116. Still, for a third example, if the type of reporting includes providing the hazard information 112, then the system(s) 702 may send data representing the hazard information 112 to the application system(s) 118.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) - such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

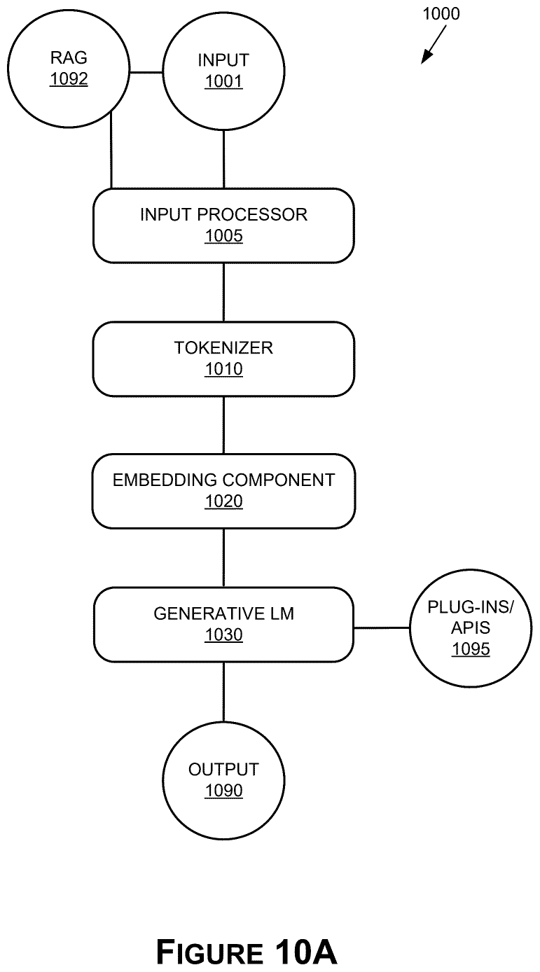

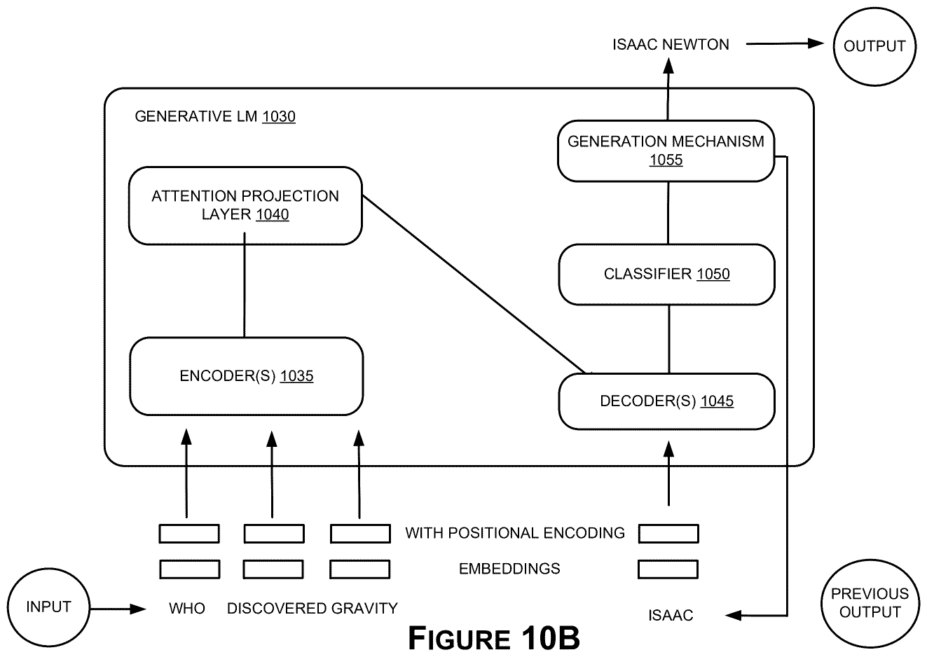

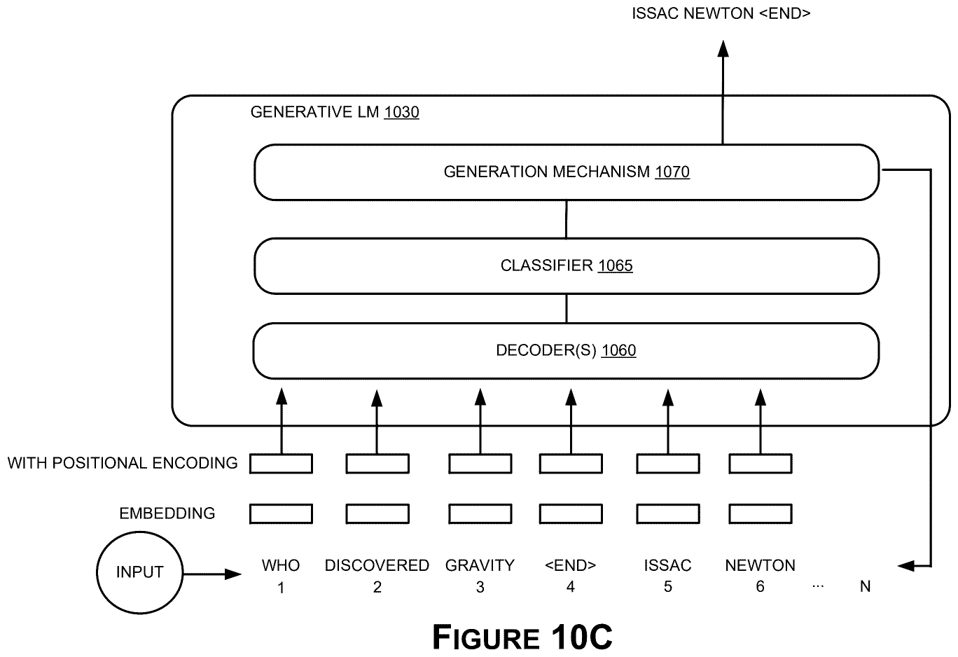

FIG. 10A is a block diagram of an example generative language model system 1000 suitable for use in implementing at least some embodiments of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer1010 of FIG. 10A) into tokens such as words, and each token is encoded (e.g., by the embedding component 1020 of FIG. 910A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Autonomous Vehicle

FIG. 11A is an illustration of an example autonomous vehicle 1100, in accordance with some embodiments of the present disclosure. The autonomous vehicle 1100 (alternatively referred to herein as the “vehicle 1100”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J 3016-201806, published on Jun. 15, 2018, Standard No. J 3016-201609, published on Sep. 30, 2016, and previous and future versions of this standard). The vehicle 1100 may be capable of functionality in accordance with one or more of Level 3—Level 5 of the autonomous driving levels. The vehicle 1100 may be capable of functionality in accordance with one or more of Level 1—Level 5 of the autonomous driving levels. For example, the vehicle 1100 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1100 or other machine, such as being fully autonomous, being highly autonomous, being conditionally autonomous, being partially autonomous, providing assistive autonomy, being semi-autonomous, being primarily autonomous, or other designation.

The vehicle 1100 may include components such as a chassis, a vehicle body, wheels (e.g., 2, 4, 6, 8, 18, etc.), tires, axles, and other components of a vehicle. The vehicle 1100 may include a propulsion system 1150, such as an internal combustion engine, hybrid electric power plant, an all-electric engine, and/or another propulsion system type. The propulsion system 1150 may be connected to a drive train of the vehicle 1100, which may include a transmission, to enable the propulsion of the vehicle 1100. The propulsion system 1150 may be controlled in response to receiving signals from the throttle/accelerator 1152.

A steering system 1154, which may include a steering wheel, may be used to steer the vehicle 1100 (e.g., along a desired path or route) when the propulsion system 1150 is operating (e.g., when the vehicle is in motion). The steering system 1154 may receive signals from a steering actuator 1156. The steering wheel may be optional for full automation (Level 5) functionality.

The brake sensor system 1146 may be used to operate the vehicle brakes in response to receiving signals from the brake actuators 1148 and/or brake sensors.

Controller(s) 1136, which may include one or more system on chips (SoCs) 1104 (FIG. 11C) and/or GPU(s), may provide signals (e.g., representative of commands) to one or more components and/or systems of the vehicle 1100. For example, the controller(s) may send signals to operate the vehicle brakes via one or more brake actuators 1148, to operate the steering system 1154 via one or more steering actuators 1156, to operate the propulsion system 1150 via one or more throttle/accelerators 1152. The controller(s) 1136 may include one or more onboard (e.g., integrated) computing devices (e.g., supercomputers) that process sensor signals, and output operation commands (e.g., signals representing commands) to enable autonomous driving and/or to assist a human driver in driving the vehicle 1100. The controller(s) 1136 may include a first controller 1136 for autonomous driving functions, a second controller 1136 for functional safety functions, a third controller 1136 for artificial intelligence functionality (e.g., computer vision), a fourth controller 1136 for infotainment functionality, a fifth controller 1136 for redundancy in emergency conditions, and/or other controllers. In some examples, a single controller 1136 may handle two or more of the above functionalities, two or more controllers 1136 may handle a single functionality, and/or any combination thereof.

The controller(s) 1136 may provide the signals for controlling one or more components and/or systems of the vehicle 1100 in response to sensor data received from one or more sensors (e.g., sensor inputs). The sensor data may be received from, for example and without limitation, global navigation satellite systems (“GNSS”) sensor(s) 1158 (e.g., Global Positioning System sensor(s)), RADAR sensor(s) 1160, ultrasonic sensor(s) 1162, LIDAR sensor(s) 1164, inertial measurement unit (IMU) sensor(s) 1166 (e.g., accelerometer(s), gyroscope(s), magnetic compass(es), magnetometer(s), etc.), microphone(s) 1196, stereo camera(s) 1168, wide-view camera(s) 1170 (e.g., fisheye cameras), infrared camera(s) 1172, surround camera(s) 1174 (e.g., 360 degree cameras), long-range and/or mid-range camera(s) 1198, speed sensor(s) 1144 (e.g., for measuring the speed of the vehicle 1100), vibration sensor(s) 1142, steering sensor(s) 1140, brake sensor(s) (e.g., as part of the brake sensor system 1146), and/or other sensor types.

One or more of the controller(s) 1136 may receive inputs (e.g., represented by input data) from an instrument cluster 1132 of the vehicle 1100 and provide outputs (e.g., represented by output data, display data, etc.) via a human-machine interface (HMI) display 1134, an audible annunciator, a loudspeaker, and/or via other components of the vehicle 1100. The outputs may include information such as vehicle velocity, speed, time, map data (e.g., the High Definition (“HD”) map 1122 of FIG. 11C), location data (e.g., the vehicle's 1100 location, such as on a map), direction, location of other vehicles (e.g., an occupancy grid), information about objects and status of objects as perceived by the controller(s) 1136, etc. For example, the HMI display 1134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1100 further includes a network interface 1124 which may use one or more wireless antenna(s) 1126 and/or modem(s) to communicate over one or more networks. For example, the network interface 1124 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1126 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 11B is an example of camera locations and fields of view for the example autonomous vehicle 1100 of FIG. 11A, in accordance with some embodiments of the present disclosure. The cameras and respective fields of view are one example embodiment and are not intended to be limiting. For example, additional and/or alternative cameras may be included and/or the cameras may be located at different locations on the vehicle 1100.

The camera types for the cameras may include, but are not limited to, digital cameras that may be adapted for use with the components and/or systems of the vehicle 1100. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1100 (e.g., front-facing cameras) may be used for surround view, to help identify forward facing paths and obstacles, as well aid in, with the help of one or more controllers 1136 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1170 that may be used to perceive objects coming into view from the periphery (e.g., pedestrians, crossing traffic or bicycles). Although only one wide-view camera is illustrated in FIG. 11B, there may be any number (including zero) of wide-view cameras 1170 on the vehicle 1100. In addition, any number of long-range camera(s) 1198 (e.g., a long-view stereo camera pair) may be used for depth-based object detection, especially for objects for which a neural network has not yet been trained. The long-range camera(s) 1198 may also be used for object detection and classification, as well as basic object tracking.

Any number of stereo cameras 1168 may also be included in a front-facing configuration. In at least one embodiment, one or more of stereo camera(s) 1168 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1168 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1168 may be used in addition to, or alternatively from, those described herein.

Cameras with a field of view that include portions of the environment to the side of the vehicle 1100 (e.g., side-view cameras) may be used for surround view, providing information used to create and update the occupancy grid, as well as to generate side impact collision warnings. For example, surround camera(s) 1174 (e.g., four surround cameras 1174 as illustrated in FIG. 11B) may be positioned to on the vehicle 1100. The surround camera(s) 1174 may include wide-view camera(s) 1170, fisheye camera(s), 360 degree camera(s), and/or the like. Four example, four fisheye cameras may be positioned on the vehicle's front, rear, and sides. In an alternative arrangement, the vehicle may use three surround camera(s) 1174 (e.g., left, right, and rear), and may leverage one or more other camera(s) (e.g., a forward-facing camera) as a fourth surround view camera.

Cameras with a field of view that include portions of the environment to the rear of the vehicle 1100 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1198, stereo camera(s) 1168), infrared camera(s) 1172, etc.), as described herein.

FIG. 11C is a block diagram of an example system architecture for the example autonomous vehicle 1100 of FIG. 11A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1100 in FIG. 11C are illustrated as being connected via bus 1102. The bus 1102 may include a Controller Area Network (CAN) data interface (alternatively referred to herein as a “CAN bus”). A CAN may be a network inside the vehicle 1100 used to aid in control of various features and functionality of the vehicle 1100, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1102 is described herein as being a CAN bus, this is not intended to be limiting. For example, in addition to, or alternatively from, the CAN bus, FlexRay and/or Ethernet may be used. Additionally, although a single line is used to represent the bus 1102, this is not intended to be limiting. For example, there may be any number of busses 1102, which may include one or more CAN busses, one or more FlexRay busses, one or more Ethernet busses, and/or one or more other types of busses using a different protocol. In some examples, two or more busses 1102 may be used to perform different functions, and/or may be used for redundancy. For example, a first bus 1102 may be used for collision avoidance functionality and a second bus 1102 may be used for actuation control. In any example, each bus 1102 may communicate with any of the components of the vehicle 1100, and two or more busses 1102 may communicate with the same components. In some examples, each SoC 1104, each controller 1136, and/or each computer within the vehicle may have access to the same input data (e.g., inputs from sensors of the vehicle 1100), and may be connected to a common bus, such the CAN bus.

The vehicle 1100 may include one or more controller(s) 1136, such as those described herein with respect to FIG. 11A. The controller(s) 1136 may be used for a variety of functions. The controller(s) 1136 may be coupled to any of the various other components and systems of the vehicle 1100, and may be used for control of the vehicle 1100, artificial intelligence of the vehicle 1100, infotainment for the vehicle 1100, and/or the like.

The vehicle 1100 may include a system(s) on a chip (SoC) 1104. The SoC 1104 may include CPU(s) 1106, GPU(s) 1108, processor(s) 1110, cache(s) 1112, accelerator(s) 1114, data store(s) 1116, and/or other components and features not illustrated. The SoC(s) 1104 may be used to control the vehicle 1100 in a variety of platforms and systems. For example, the SoC(s) 1104 may be combined in a system (e.g., the system of the vehicle 1100) with an HD map 1122 which may obtain map refreshes and/or updates via a network interface 1124 from one or more servers (e.g., server(s) 1178 of FIG. 11D).

The CPU(s) 1106 may include a CPU cluster or CPU complex (alternatively referred to herein as a “CCPLEX”). The CPU(s) 1106 may include multiple cores and/or L2 caches. For example, in some embodiments, the CPU(s) 1106 may include eight cores in a coherent multi-processor configuration. In some embodiments, the CPU(s) 1106 may include four dual-core clusters where each cluster has a dedicated L2 cache (e.g., a 2 MB L2 cache). The CPU(s) 1106 (e.g., the CCPLEX) may be configured to support simultaneous cluster operation enabling any combination of the clusters of the CPU(s) 1106 to be active at any given time.

The CPU(s) 1106 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1106 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1108 may include an integrated GPU (alternatively referred to herein as an “iGPU”). The GPU(s) 1108 may be programmable and may be efficient for parallel workloads. The GPU(s) 1108, in some examples, may use an enhanced tensor instruction set. The GPU(s) 1108 may include one or more streaming microprocessors, where each streaming microprocessor may include an L1 cache (e.g., an L1 cache with at least 96KB storage capacity), and two or more of the streaming microprocessors may share an L2 cache (e.g., an L2 cache with a 512 KB storage capacity). In some embodiments, the GPU(s) 1108 may include at least eight streaming microprocessors. The GPU(s) 1108 may use compute application programming interface(s) (API(s)). In addition, the GPU(s) 1108 may use one or more parallel computing platforms and/or programming models (e.g., NVIDIA's CUDA).

The GPU(s) 1108 may be power-optimized for best performance in automotive and embedded use cases. For example, the GPU(s) 1108 may be fabricated on a Fin field-effect transistor (FinFET). However, this is not intended to be limiting and the GPU(s) 1108 may be fabricated using other semiconductor manufacturing processes. Each streaming microprocessor may incorporate a number of mixed-precision processing cores partitioned into multiple blocks. For example, and without limitation, 64 PF32 cores and 32 PF 64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1108 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1108 to access the CPU(s) 1106 page tables directly. In such examples, when the GPU(s) 1108 memory management unit (MMU) experiences a miss, an address translation request may be transmitted to the CPU(s) 1106. In response, the CPU(s) 1106 may look in its page tables for the virtual-to-physical mapping for the address and transmits the translation back to the GPU(s) 1108. As such, unified memory technology may allow a single unified virtual address space for memory of both the CPU(s) 1106 and the GPU(s) 1108, thereby simplifying the GPU(s) 1108 programming and porting of applications to the GPU(s) 1108.

In addition, the GPU(s) 1108 may include an access counter that may keep track of the frequency of access of the GPU(s) 1108 to memory of other processors. The access counter may help ensure that memory pages are moved to the physical memory of the processor that is accessing the pages most frequently.

The SoC(s) 1104 may include any number of cache(s) 1112, including those described herein. For example, the cache(s) 1112 may include an L3 cache that is available to both the CPU(s) 1106 and the GPU(s) 1108 (e.g., that is connected both the CPU(s) 1106 and the GPU(s) 1108). The cache(s) 1112 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1104 may include an arithmetic logic unit(s) (ALU(s)) which may be leveraged in performing processing with respect to any of the variety of tasks or operations of the vehicle 1100—such as processing DNNs. In addition, the SoC(s) 1104 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1106 and/or GPU(s) 1108.

The SoC(s) 1104 may include one or more accelerators 1114 (e.g., hardware accelerators, software accelerators, or a combination thereof). For example, the SoC(s) 1104 may include a hardware acceleration cluster that may include optimized hardware accelerators and/or large on-chip memory. The large on-chip memory (e.g., 4MB of SRAM), may enable the hardware acceleration cluster to accelerate neural networks and other calculations. The hardware acceleration cluster may be used to complement the GPU(s) 1108 and to off-load some of the tasks of the GPU(s) 1108 (e.g., to free up more cycles of the GPU(s) 1108 for performing other tasks). As an example, the accelerator(s) 1114 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1114 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1108, and by using an inference accelerator, for example, a designer may target either the DLA(s) or the GPU(s) 1108 for any function. For example, the designer may focus processing of CNNs and floating point operations on the DLA(s) and leave other functions to the GPU(s) 1108 and/or other accelerator(s) 1114.

The accelerator(s) 1114 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1106. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1114 (e.g., the hardware acceleration cluster) may include a computer vision network on-chip and SRAM, for providing a high-bandwidth, low latency SRAM for the accelerator(s) 1114. In some examples, the on-chip memory may include at least 4MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1104 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1114 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1166 output that correlates with the vehicle 1100 orientation, distance, 3D location estimates of the object obtained from the neural network and/or other sensors (e.g., LIDAR sensor(s) 1164 or RADAR sensor(s) 1160), among others.

The SoC(s) 1104 may include data store(s) 1116 (e.g., memory). The data store(s) 1116 may be on-chip memory of the SoC(s) 1104, which may store neural networks to be executed on the GPU and/or the DLA. In some examples, the data store(s) 1116 may be large enough in capacity to store multiple instances of neural networks for redundancy and safety. The data store(s) 1112 may comprise L2 or L3 cache(s) 1112. Reference to the data store(s) 1116 may include reference to the memory associated with the PVA, DLA, and/or other accelerator(s) 1114, as described herein.

The SoC(s) 1104 may include one or more processor(s) 1110 (e.g., embedded processors). The processor(s) 1110 may include a boot and power management processor that may be a dedicated processor and subsystem to handle boot power and management functions and related security enforcement. The boot and power management processor may be a part of the SoC(s) 1104 boot sequence and may provide runtime power management services. The boot power and management processor may provide clock and voltage programming, assistance in system low power state transitions, management of SoC(s) 1104 thermals and temperature sensors, and/or management of the SoC(s) 1104 power states. Each temperature sensor may be implemented as a ring-oscillator whose output frequency is proportional to temperature, and the SoC(s) 1104 may use the ring-oscillators to detect temperatures of the CPU(s) 1106, GPU(s) 1108, and/or accelerator(s) 1114. If temperatures are determined to exceed a threshold, the boot and power management processor may enter a temperature fault routine and put the SoC(s) 1104 into a lower power state and/or put the vehicle 1100 into a chauffeur to safe stop mode (e.g., bring the vehicle 1100 to a safe stop).

The processor(s) 1110 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1110 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1110 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1110 may further include a real-time camera engine that may include a dedicated processor subsystem for handling real-time camera management.

The processor(s) 1110 may further include a high-dynamic range signal processor that may include an image signal processor that is a hardware engine that is part of the camera processing pipeline.

The processor(s) 1110 may include a video image compositor that may be a processing block (e.g., implemented on a microprocessor) that implements video post-processing functions needed by a video playback application to produce the final image for the player window. The video image compositor may perform lens distortion correction on wide-view camera(s) 1170, surround camera(s) 1174, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1108 is not required to continuously render new surfaces. Even when the GPU(s) 1108 is powered on and active doing 3D rendering, the video image compositor may be used to offload the GPU(s) 1108 to improve performance and responsiveness.

The SoC(s) 1104 may further include a mobile industry processor interface (MIPI) camera serial interface for receiving video and input from cameras, a high-speed interface, and/or a video input block that may be used for camera and related pixel input functions. The SoC(s) 1104 may further include an input/output controller(s) that may be controlled by software and may be used for receiving I/O signals that are uncommitted to a specific role.

The SoC(s) 1104 may further include a broad range of peripheral interfaces to enable communication with peripherals, audio codecs, power management, and/or other devices. The SoC(s) 1104 may be used to process data from cameras (e.g., connected over Gigabit Multimedia Serial Link and Ethernet), sensors (e.g., LIDAR sensor(s) 1164, RADAR sensor(s) 1160, etc. that may be connected over Ethernet), data from bus 1102 (e.g., speed of vehicle 1100, steering wheel position, etc.), data from GNSS sensor(s) 1158 (e.g., connected over Ethernet or CAN bus). The SoC(s) 1104 may further include dedicated high-performance mass storage controllers that may include their own DMA engines, and that may be used to free the CPU(s) 1106 from routine data management tasks.

The SoC(s) 1104 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1104 may be faster, more reliable, and even more energy-efficient and space-efficient than conventional systems. For example, the accelerator(s) 1114, when combined with the CPU(s) 1106, the GPU(s) 1108, and the data store(s) 1116, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1120) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1108.

In some examples, a CNN for facial recognition and vehicle owner identification may use data from camera sensors to identify the presence of an authorized driver and/or owner of the vehicle 1100. The always on sensor processing engine may be used to unlock the vehicle when the owner approaches the driver door and turn on the lights, and, in security mode, to disable the vehicle when the owner leaves the vehicle. In this way, the SoC(s) 1104 provide for security against theft and/or carjacking.

In another example, a CNN for emergency vehicle detection and identification may use data from microphones 1196 to detect and identify emergency vehicle sirens. In contrast to conventional systems, that use general classifiers to detect sirens and manually extract features, the SoC(s) 1104 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1158. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1162, until the emergency vehicle(s) passes.

The vehicle may include a CPU(s) 1118 (e.g., discrete CPU(s), or dCPU(s)), that may be coupled to the SoC(s) 1104 via a high-speed interconnect (e.g., PCIe). The CPU(s) 1118 may include an X86 processor, for example. The CPU(s) 1118 may be used to perform any of a variety of functions, including arbitrating potentially inconsistent results between ADAS sensors and the SoC(s) 1104, and/or monitoring the status and health of the controller(s) 1136 and/or infotainment SoC 1130, for example.

The vehicle 1100 may include a GPU(s) 1120 (e.g., discrete GPU(s), or dGPU(s)), that may be coupled to the SoC(s) 1104 via a high-speed interconnect (e.g., NVIDIA's NVLINK). The GPU(s) 1120 may provide additional artificial intelligence functionality, such as by executing redundant and/or different neural networks, and may be used to train and/or update neural networks based on input (e.g., sensor data) from sensors of the vehicle 1100.

The vehicle 1100 may further include the network interface 1124 which may include one or more wireless antennas 1126 (e.g., one or more wireless antennas for different communication protocols, such as a cellular antenna, a Bluetooth antenna, etc.). The network interface 1124 may be used to enable wireless connectivity over the Internet with the cloud (e.g., with the server(s) 1178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1100 information about vehicles in proximity to the vehicle 1100 (e.g., vehicles in front of, on the side of, and/or behind the vehicle 1100). This functionality may be part of a cooperative adaptive cruise control functionality of the vehicle 1100.

The network interface 1124 may include a SoC that provides modulation and demodulation functionality and enables the controller(s) 1136 to communicate over wireless networks. The network interface 1124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1100 may further include data store(s) 1128 which may include off-chip (e.g., off the SoC(s) 1104) storage. The data store(s) 1128 may include one or more storage elements including RAM, SRAM, DRAM, VRAM, Flash, hard disks, and/or other components and/or devices that may store at least one bit of data.

The vehicle 1100 may further include GNSS sensor(s) 1158. The GNSS sensor(s) 1158 (e.g., GPS, assisted GPS sensors, differential GPS (DGPS) sensors, etc.), to assist in mapping, perception, occupancy grid generation, and/or path planning functions. Any number of GNSS sensor(s) 1158 may be used, including, for example and without limitation, a GPS using a USB connector with an Ethernet to Serial (RS-232) bridge.

The vehicle 1100 may further include RADAR sensor(s) 1160. The RADAR sensor(s) 1160 may be used by the vehicle 1100 for long-range vehicle detection, even in darkness and/or severe weather conditions. RADAR functional safety levels may be ASIL B. The RADAR sensor(s) 1160 may use the CAN and/or the bus 1102 (e.g., to transmit data generated by the RADAR sensor(s) 1160) for control and to access object tracking data, with access to Ethernet to access raw data in some examples. A wide variety of RADAR sensor types may be used. For example, and without limitation, the RADAR sensor(s) 1160 may be suitable for front, rear, and side RADAR use. In some example, Pulse Doppler RADAR sensor(s) are used.

The RADAR sensor(s) 1160 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1160 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1100 surroundings at higher speeds with minimal interference from traffic in adjacent lanes. The other two antennae may expand the field of view, making it possible to quickly detect vehicles entering or leaving the vehicle's 1100 lane.

Mid-range RADAR systems may include, as an example, a range of up to 1160 m (front) or 80 m (rear), and a field of view of up to 42 degrees (front) or 1150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1100 may further include ultrasonic sensor(s) 1162. The ultrasonic sensor(s) 1162, which may be positioned at the front, back, and/or the sides of the vehicle 1100, may be used for park assist and/or to create and update an occupancy grid. A wide variety of ultrasonic sensor(s) 1162 may be used, and different ultrasonic sensor(s) 1162 may be used for different ranges of detection (e.g., 2.5 m, 4 m). The ultrasonic sensor(s) 1162 may operate at functional safety levels of ASIL B.

The vehicle 1100 may include LIDAR sensor(s) 1164. The LIDAR sensor(s) 1164 may be used for object and pedestrian detection, emergency braking, collision avoidance, and/or other functions. The LIDAR sensor(s) 1164 may be functional safety level ASIL B. In some examples, the vehicle 1100 may include multiple LIDAR sensors 1164 (e.g., two, four, six, etc.) that may use Ethernet (e.g., to provide data to a Gigabit Ethernet switch).

In some examples, the LIDAR sensor(s) 1164 may be capable of providing a list of objects and their distances for a 360-degree field of view. Commercially available LIDAR sensor(s) 1164 may have an advertised range of approximately 1100 m, with an accuracy of 2 cm-3 cm, and with support for a 1100 Mbps Ethernet connection, for example. In some examples, one or more non-protruding LIDAR sensors 1164 may be used. In such examples, the LIDAR sensor(s) 1164 may be implemented as a small device that may be embedded into the front, rear, sides, and/or corners of the vehicle 1100. The LIDAR sensor(s) 1164, in such examples, may provide up to a 120-degree horizontal and 35-degree vertical field-of-view, with a 200 m range even for low-reflectivity objects. Front-mounted LIDAR sensor(s) 1164 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1100. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1164 may be less susceptible to motion blur, vibration, and/or shock.

The vehicle may further include IMU sensor(s) 1166. The IMU sensor(s) 1166 may be located at a center of the rear axle of the vehicle 1100, in some examples. The IMU sensor(s) 1166 may include, for example and without limitation, an accelerometer(s), a magnetometer(s), a gyroscope(s), a magnetic compass(es), and/or other sensor types. In some examples, such as in six-axis applications, the IMU sensor(s) 1166 may include accelerometers and gyroscopes, while in nine-axis applications, the IMU sensor(s) 1166 may include accelerometers, gyroscopes, and magnetometers.

In some embodiments, the IMU sensor(s) 1166 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1166 may enable the vehicle 1100 to estimate heading without requiring input from a magnetic sensor by directly observing and correlating the changes in velocity from GPS to the IMU sensor(s) 1166. In some examples, the IMU sensor(s) 1166 and the GNSS sensor(s) 1158 may be combined in a single integrated unit.

The vehicle may include microphone(s) 1196 placed in and/or around the vehicle 1100. The microphone(s) 1196 may be used for emergency vehicle detection and identification, among other things.

The vehicle may further include any number of camera types, including stereo camera(s) 1168, wide-view camera(s) 1170, infrared camera(s) 1172, surround camera(s) 1174, long-range and/or mid-range camera(s) 1198, and/or other camera types. The cameras may be used to capture image data around an entire periphery of the vehicle 1100. The types of cameras used depends on the embodiments and requirements for the vehicle 1100, and any combination of camera types may be used to provide the necessary coverage around the vehicle 1100. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 11A and FIG. 11B.

The vehicle 1100 may further include vibration sensor(s) 1142. The vibration sensor(s) 1142 may measure vibrations of components of the vehicle, such as the axle(s). For example, changes in vibrations may indicate a change in road surfaces. In another example, when two or more vibration sensors 1142 are used, the differences between the vibrations may be used to determine friction or slippage of the road surface (e.g., when the difference in vibration is between a power-driven axle and a freely rotating axle).

The vehicle 1100 may include an ADAS system 1138. The ADAS system 1138 may include a SoC, in some examples. The ADAS system 1138 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1160, LIDAR sensor(s) 1164, and/or a camera(s). The ACC systems may include longitudinal ACC and/or lateral ACC. Longitudinal ACC monitors and controls the distance to the vehicle immediately ahead of the vehicle 1100 and automatically adjust the vehicle speed to maintain a safe distance from vehicles ahead. Lateral ACC performs distance keeping, and advises the vehicle 1100 to change lanes when necessary. Lateral ACC is related to other ADAS applications such as LCA and CWS.

CACC uses information from other vehicles that may be received via the network interface 1124 and/or the wireless antenna(s) 1126 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1100), while the I2V communication concept provides information about traffic further ahead. CACC systems may include either or both I2V and V2V information sources. Given the information of the vehicles ahead of the vehicle 1100, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1160, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1160, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1100 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1100 if the vehicle 1100 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1160, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1100 is backing up. Some RCTW systems include AEB to ensure that the vehicle brakes are applied to avoid a crash. RCTW systems may use one or more rear-facing RADAR sensor(s) 1160, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1100, the vehicle 1100 itself must, in the case of conflicting results, decide whether to heed the result from a primary computer or a secondary computer (e.g., a first controller 1136 or a second controller 1136). For example, in some embodiments, the ADAS system 1138 may be a backup and/or secondary computer for providing perception information to a backup computer rationality module. The backup computer rationality monitor may run a redundant diverse software on hardware components to detect faults in perception and dynamic driving tasks. Outputs from the ADAS system 1138 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1104.

In other examples, ADAS system 1138 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1138 may be fed into the primary computer's perception block and/or the primary computer's dynamic driving task block. For example, if the ADAS system 1138 indicates a forward crash warning due to an object immediately ahead, the perception block may use this information when identifying objects. In other examples, the secondary computer may have its own neural network which is trained and thus reduces the risk of false positives, as described herein.

The vehicle 1100 may further include the infotainment SoC 1130 (e.g., an in-vehicle infotainment system (IVI)). Although illustrated and described as a SoC, the infotainment system may not be a SoC, and may include two or more discrete components. The infotainment SoC 1130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1100. For example, the infotainment SoC 1130 may radios, disk players, navigation systems, video players, USB and Bluetooth connectivity, carputers, in-car entertainment, Wi-Fi, steering wheel audio controls, hands free voice control, a heads-up display (HUD), an HMI display 1134, a telematics device, a control panel (e.g., for controlling and/or interacting with various components, features, and/or systems), and/or other components. The infotainment SoC 1130 may further be used to provide information (e.g., visual and/or audible) to a user(s) of the vehicle, such as information from the ADAS system 1138, autonomous driving information such as planned vehicle maneuvers, trajectories, surrounding environment information (e.g., intersection information, vehicle information, road information, etc.), and/or other information.

The infotainment SoC 1130 may include GPU functionality. The infotainment SoC 1130 may communicate over the bus 1102 (e.g., CAN bus, Ethernet, etc.) with other devices, systems, and/or components of the vehicle 1100. In some examples, the infotainment SoC 1130 may be coupled to a supervisory MCU such that the GPU of the infotainment system may perform some self-driving functions in the event that the primary controller(s) 1136 (e.g., the primary and/or backup computers of the vehicle 1100) fail. In such an example, the infotainment SoC 1130 may put the vehicle 1100 into a chauffeur to safe stop mode, as described herein.

The vehicle 1100 may further include an instrument cluster 1132 (e.g., a digital dash, an electronic instrument cluster, a digital instrument panel, etc.). The instrument cluster 1132 may include a controller and/or supercomputer (e.g., a discrete controller or supercomputer). The instrument cluster 1132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1130 and the instrument cluster 1132. In other words, the instrument cluster 1132 may be included as part of the infotainment SoC 1130, or vice versa.

FIG. 11D is a system diagram for communication between cloud-based server(s) and the example autonomous vehicle 1100 of FIG. 11A, in accordance with some embodiments of the present disclosure. The system 1176 may include server(s) 1178, network(s) 1190, and vehicles, including the vehicle 1100. The server(s) 1178 may include a plurality of GPUs 1184(A)-1184(H) (collectively referred to herein as GPUs 1184), PCIe switches 1182(A)-1182(H) (collectively referred to herein as PCIe switches 1182), and/or CPUs 1180(A)-1180(B) (collectively referred to herein as CPUs 1180). The GPUs 1184, the CPUs 1180, and the PCIe switches may be interconnected with high-speed interconnects such as, for example and without limitation, NVLink interfaces 1188 developed by NVIDIA and/or PCIe connections 1186. In some examples, the GPUs 1184 are connected via NVLink and/or NVSwitch SoC and the GPUs 1184 and the PCIe switches 1182 are connected via PCIe interconnects. Although eight GPUs 1184, two CPUs 1180, and two PCIe switches are illustrated, this is not intended to be limiting. Depending on the embodiment, each of the server(s) 1178 may include any number of GPUs 1184, CPUs 1180, and/or PCIe switches. For example, the server(s) 1178 may each include eight, sixteen, thirty-two, and/or more GPUs 1184.

The server(s) 1178 may receive, over the network(s) 1190 and from the vehicles, image data representative of images showing unexpected or changed road conditions, such as recently commenced road-work. The server(s) 1178 may transmit, over the network(s) 1190 and to the vehicles, neural networks 1192, updated neural networks 1192, and/or map information 1194, including information regarding traffic and road conditions. The updates to the map information 1194 may include updates for the HD map 1122, such as information regarding construction sites, potholes, detours, flooding, and/or other obstructions. In some examples, the neural networks 1192, the updated neural networks 1192, and/or the map information 1194 may have resulted from new training and/or experiences represented in data received from any number of vehicles in the environment, and/or based on training performed at a datacenter (e.g., using the server(s) 1178 and/or other servers).

The server(s) 1178 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1190, and/or the machine learning models may be used by the server(s) 1178 to remotely monitor the vehicles.

In some examples, the server(s) 1178 may receive data from the vehicles and apply the data to up-to-date real-time neural networks for real-time intelligent inferencing. The server(s) 1178 may include deep-learning supercomputers and/or dedicated AI computers powered by GPU(s) 1184, such as a DGX and DGX Station machines developed by NVIDIA. However, in some examples, the server(s) 1178 may include deep learning infrastructure that use only CPU-powered datacenters.

The deep-learning infrastructure of the server(s) 1178 may be capable of fast, real-time inferencing, and may use that capability to evaluate and verify the health of the processors, software, and/or associated hardware in the vehicle 1100. For example, the deep-learning infrastructure may receive periodic updates from the vehicle 1100, such as a sequence of images and/or objects that the vehicle 1100 has located in that sequence of images (e.g., via computer vision and/or other machine learning object classification techniques). The deep-learning infrastructure may run its own neural network to identify the objects and compare them with the objects identified by the vehicle 1100 and, if the results do not match and the infrastructure concludes that the AI in the vehicle 1100 is malfunctioning, the server(s) 1178 may transmit a signal to the vehicle 1100 instructing a fail-safe computer of the vehicle 1100 to assume control, notify the passengers, and complete a safe parking maneuver.

For inferencing, the server(s) 1178 may include the GPU(s) 1184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices:
memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1333, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1333 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1333. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: determining, based at least on sensor data obtained using one or more first sensors of a machine, a location associated with the machine within an environment; determining, based at least on one or more vision-language models processing at least image data obtained using one or more second sensors of the machine, information associated with a road hazard located within the environment; and sending, to one or more systems, data for updating one or more applications to indicate at least a portion of the information associated with the road hazard at approximately the location.

B: The method of paragraph A, further comprising: determining, based at least on one or more language models processing second data representing the information, a request to verify the information; providing content associated with the request to verify the information; and receiving input data indicating that the information associated with the road hazard is verified, wherein the sending the data for updating the one or more applications is based at least on the road hazard being verified.

C: The method of either paragraph A or paragraph B, further comprising:
determining, based at least on one or more language models processing second data representing the information, a request for second information associated with the road hazard; providing content associated with the request for the second information; and receiving input data indicating the second information associated with the road hazard, wherein the data is further for updating the one or more applications to indicate at least a portion of the second information.

D: The method of any one of paragraphs A-C, wherein the determining the information associated with the road hazard is further based at least on the one or more vision-language models processing second data representing at least one of: a first prompt requesting the information associated with the road hazard potentially located within the environment; or a second prompt requesting second information associated with one or more road hazards potentially located within the environment, the one or more road hazards including at least the road hazard.

E: The method of any one of paragraphs A-D, wherein: the determining the information associated with the road hazard is further based at least on the one or more vision-language models processing second data representing a first prompt associated with the road hazard; and the method further comprises determining, based at least on the one or more vision-language models processing at least the image data and third data representing a second prompt associated with a second road hazard, second information associated with the second road hazard potentially located within the environment.

F: The method of any one of paragraphs A-E, wherein the determining the information associated with the road hazard comprises: determining, based at least on the one or more vision-language models processing the image data and second data representing a first prompt, initial information indicating that the road hazard is located within the environment; and determining, based at least on the one or more vision-language models processing the image data and third data representing the initial information and a second prompt, the information associated with the road hazard.

G: The method of any one of paragraphs A-F, further comprising: determining, based at least on second sensor data obtained using one or more third sensors of the machine, second information associated with the road hazard, wherein the data is further for updating the one or more applications to indicate at least a portion of the second information associated with the road hazard.

H: The method of any one of paragraphs A-G, wherein the information associated with the road hazard describes at least one of: a type of the hazard; a location of the hazard within the environment; or a location of the hazard as represented using one or more images represented by the image data.

I: The method of any one of paragraphs A-H, wherein the road hazard includes at least one of: an obstruction located proximate to a driving surface; an emergency service occurring proximate to the driving surface; construction associated with the driving surface; an animal located proximate to the driving surface; a pedestrian being located proximate to the driving surface; or a dangerous road condition associated with the driving surface.

J: A system comprising: one or more processors to: obtain sensor data obtained using one or more sensors of a machine navigating within an environment; determine, using one or more machine learning models and based at least the sensor data and one or more prompts associated with one or more hazards, information corresponding a hazard located within the environment; and send, to one or more systems, data associated with the information corresponding the hazard, the data for updating an application to indicate the information corresponding to the hazard.

K: The system of paragraph J, wherein the one or more processors are further to: determine, based at least on second sensor data obtained using one or more second sensors, a location associated with the hazard, wherein the data is further associated with the information.

L: The system of either paragraph J or paragraph K, wherein the one or more processors are further to: determine, using the one or more machine learning models and based at least on the information, a request to verify the information; provide content associated with the request to verify the information; and receive input data indicating that the information associated with the hazard is verified, wherein the data is sent based at least on the hazard being verified.

M: The system of any one of paragraphs J-L, wherein the one or more processors are further to: determine, using the one or more machine learning models and based at least on the information, a request for second information associated with the hazard; provide content associated with the request for the second information; and receive input data indicating the second information associated with the hazard, wherein the data is further associated with the second information.

N: The system of any one of paragraphs J-M wherein the one or more processors are further to: determine, using the one or more machine learning models and based at least on the information, to provide the information for updating the application, wherein the data is sent based at least on the determination to provide the information.

O: The system of any one of paragraphs J-N, wherein the one or more processors are further to determine, using one or more machine learning models and based at least the sensor data and a prompt associated with one or more second hazards, second information corresponding a second hazard potentially located within the environment.

P: The system of any one of paragraphs J-O, wherein the determination of the information associated with the hazard comprises: determining, using the one or more machine learning models and based at least on the sensor data and a first prompt of the one or more prompts, initial information indicating that the hazard is located within the environment; and determining, using the one or more machine learning models and based at least on the sensor data, the initial information, and a second prompt of the one or more prompts, the information associated with the hazard.

Q: The system of any one of paragraphs J-P, wherein the one or more processors are further to: determine, based at least on second sensor data obtained using one or more second sensors of the machine, second information associated with the hazard, wherein the data is further associated with the second information.

R: The system of any one of paragraphs J-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using the one or more vision-language models; a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

S: An autonomous or semi-autonomous machine comprising: one or more central processing units (CPUs); one or more graphics processing units (GPUs); one or more hardware accelerators; and one or more external sensors having fields of view or sensory fields external to the autonomous or semi-autonomous machine, wherein the autonomous or semi-autonomous machine sends data representing information associated with a hazard to one or more systems, the information being determined based at least on one or more language models processing one or more prompts associated with the hazard and sensor data obtained using the one or more external sensors.

T: The machine of paragraph S, wherein the machine includes or is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using the one or more vision-language models; a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
determining, based at least on sensor data obtained using one or more first sensors of a machine, a location associated with the machine within an environment;
determining, based at least on one or more vision-language models processing at least image data obtained using one or more second sensors of the machine, information associated with a road hazard located within the environment; and
sending, to one or more systems, data for updating one or more applications to indicate at least a portion of the information associated with the road hazard at approximately the location.

2. The method of claim 1, further comprising:
determining, based at least on one or more language models processing second data representing the information, a request to verify the information;
providing content associated with the request to verify the information; and
receiving input data indicating that the information associated with the road hazard is verified,
wherein the sending the data for updating the one or more applications is based at least on the road hazard being verified.

3. The method of claim 1, further comprising:
determining, based at least on one or more language models processing second data representing the information, a request for second information associated with the road hazard;
providing content associated with the request for the second information; and
receiving input data indicating the second information associated with the road hazard,
wherein the data is further for updating the one or more applications to indicate at least a portion of the second information.

4. The method of claim 1, wherein the determining the information associated with the road hazard is further based at least on the one or more vision-language models processing second data representing at least one of:
a first prompt requesting the information associated with the road hazard potentially located within the environment; or
a second prompt requesting second information associated with one or more road hazards potentially located within the environment, the one or more road hazards including at least the road hazard.

5. The method of claim 1, wherein:
the determining the information associated with the road hazard is further based at least on the one or more vision-language models processing second data representing a first prompt associated with the road hazard; and
the method further comprises determining, based at least on the one or more vision-language models processing at least the image data and third data representing a second prompt associated with a second road hazard, second information associated with the second road hazard potentially located within the environment.

6. The method of claim 1, wherein the determining the information associated with the road hazard comprises:
determining, based at least on the one or more vision-language models processing the image data and second data representing a first prompt, initial information indicating that the road hazard is located within the environment; and
determining, based at least on the one or more vision-language models processing the image data and third data representing the initial information and a second prompt, the information associated with the road hazard.

7. The method of claim 1, further comprising:
determining, based at least on second sensor data obtained using one or more third sensors of the machine, second information associated with the road hazard,
wherein the data is further for updating the one or more applications to indicate at least a portion of the second information associated with the road hazard.

8. The method of claim 1, wherein the information associated with the road hazard describes at least one of:
a type of the hazard;
a location of the hazard within the environment; or
a location of the hazard as represented using one or more images represented by the image data.

9. The method of claim 1, wherein the road hazard includes at least one of:
an obstruction located proximate to a driving surface;
an emergency service occurring proximate to the driving surface;
construction associated with the driving surface;
an animal located proximate to the driving surface;
a pedestrian being located proximate to the driving surface; or a dangerous road condition associated with the driving surface.

10. A system comprising:
one or more processors to:
obtain sensor data obtained using one or more sensors of a machine navigating within an environment;
determine, using one or more machine learning models and based at least the sensor data and one or more prompts associated with one or more hazards, information corresponding a hazard located within the environment; and
send, to one or more systems, data associated with the information corresponding the hazard, the data for updating an application to indicate the information corresponding to the hazard.

11. The system of claim 10, wherein the one or more processors are further to:
determine, based at least on second sensor data obtained using one or more second sensors, a location associated with the hazard,
wherein the data is further associated with the information.

12. The system of claim 10, wherein the one or more processors are further to:
determine, using the one or more machine learning models and based at least on the information, a request to verify the information;
provide content associated with the request to verify the information; and
receive input data indicating that the information associated with the hazard is verified,
wherein the data is sent based at least on the hazard being verified.

13. The system of claim 10, wherein the one or more processors are further to:
determine, using the one or more machine learning models and based at least on the information, a request for second information associated with the hazard;
provide content associated with the request for the second information; and
receive input data indicating the second information associated with the hazard,
wherein the data is further associated with the second information.

14. The system of claim 10, wherein the one or more processors are further to:
determine, using the one or more machine learning models and based at least on the information, to provide the information for updating the application,
wherein the data is sent based at least on the determination to provide the information.

15. The system of claim 10, wherein the one or more processors are further to determine, using one or more machine learning models and based at least the sensor data and a prompt associated with one or more second hazards, second information corresponding a second hazard potentially located within the environment.

16. The system of claim 10, wherein the determination of the information associated with the hazard comprises:
determining, using the one or more machine learning models and based at least on the sensor data and a first prompt of the one or more prompts, initial information indicating that the hazard is located within the environment; and
determining, using the one or more machine learning models and based at least on the sensor data, the initial information, and a second prompt of the one or more prompts, the information associated with the hazard.

17. The system of claim 10, wherein the one or more processors are further to:
determine, based at least on second sensor data obtained using one or more second sensors of the machine, second information associated with the hazard,
wherein the data is further associated with the second information.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using the one or more vision-language models;
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. An autonomous or semi-autonomous machine comprising:
one or more central processing units (CPUs);
one or more graphics processing units (GPUs);
one or more hardware accelerators; and
one or more external sensors having fields of view or sensory fields external to the autonomous or semi-autonomous machine,
wherein the autonomous or semi-autonomous machine sends data representing information associated with a hazard to one or more systems, the information being determined based at least on one or more language models processing one or more prompts associated with the hazard and sensor data obtained using the one or more external sensors.

20. The machine of claim 19, wherein the machine includes or is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using the one or more vision=language models;
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
